(19) United States
(12) Patent Application Publication
(10) Pub. No.: US 2012/0189101 A1
(43) Pub. Date: Jul. 26, 2012

(54) RADIOGRAPHIC IMAGING APPARATUS AND RADIOGRAPHIC IMAGE DETECTOR

(75) Inventor: Yasuhisa KANEKO, Ashigarakami-gun (JP)

(73) Assignee: FUJIFILM CORPORATION, Tokyo (JP)

(21) Appl. No.: 13/357,128

(22) Filed: Jan. 24, 2012

(30) Foreign Application Priority Data
Jan. 26, 2011 (JP) 2011-014003
Jan. 18, 2012 (JP) 2012-007776

(51) Int. Cl. G01N 23/04; G01T 1/24

(52) U.S. Cl. 378/62; 250/370.09

(57) ABSTRACT

A radiographic imaging apparatus for obtaining a phase contrast image by using two gratings including a first grating and a second grating, wherein one of the first grating and the second grating includes a plurality of unit gratings arranged in a predetermined range corresponding to each pixel forming the phase contrast image, wherein the unit gratings are formed by sets of unit grating members extending in different directions from each other, and a pixel signal of each pixel of the phase contrast image is generated based on a plurality of detection signals detected by the pixel sections corresponding to the unit gratings in the predetermined range.

### BACKGROUND OF THE INVENTION

1. Field of the Invention

The present invention relates to a radiographic imaging apparatus using a grating, and a radiographic image detector for use with the radiographic imaging apparatus.

2. Description of the Related Art

X-rays have a nature that they attenuate depending on the atomic number of an element forming a substance and the density and thickness of the substance. Because of this nature, X-rays are used as a probe to investigate the interior of a subject. Imaging systems using X-rays have widely been used in the fields of medical diagnosis, nondestructive testing, etc.

With a typical X-ray imaging system, a subject is placed between an X-ray source, which emits an X-ray, and an X-ray image detector, which detects an X-ray image, to take a transmission image of the subject. In this case, each X-ray emitted from the X-ray source toward the X-ray image detector attenuates (is absorbed) by an amount depending on a difference of characteristics (such as the atomic number, density and thickness) of substances forming the subject present in the path from the X-ray source to the X-ray image detector before the X-ray enters the X-ray image detector. As a result, an X-ray transmission image of the subject is detected and imaged by the X-ray image detector. As examples of such an X-ray image detector, a combination of an X-ray intensifying screen and a film, a photostimulable phosphor, and a flat panel detector (FPD) using a semiconductor circuit are widely used.

However, the smaller the atomic number of an element forming a substance, the lower the X-ray absorbing capability of the substance. Therefore, there is only a small difference of the X-ray absorbing capability between soft biological tissues or soft materials, and it is difficult to obtain a sufficient contrast of an image as the X-ray transmission image. For example, articular cartilages forming a joint of a human body and synovial fluids around the cartilages are composed mostly of water, and there is only a small difference of the X-ray absorption therebetween. It is therefore difficult to obtain an image with sufficient contrast.

In recent years, X-ray phase-contrast imaging for obtaining a phase contrast image based on phase variation of X-rays due to differences between refractive indexes of a subject, in place of the intensity variation of X-rays due to differences between absorption coefficients of a subject, have been studied. With this X-ray phase-contrast imaging using the phase difference, a high contrast image can be obtained even in the case where a subject is a substance having low X-ray absorbing capability.

As examples of such X-ray phase-contrast imaging systems, International Patent Publication No. WO2008/102654 and Japanese Unexamined Patent Publication No. 2010-190777 (which will hereinafter be referred to as Patent Documents 1 and 2, respectively) propose radiographic phase-contrast imaging apparatuses, wherein two gratings including a first grating and a second grating are arranged parallel to each other at a predetermined interval, a self image of the first grating is formed at a position of the second grating based on the Talbot interference effect, and the intensity of the self image of the first grating is modulated with the second grating to provide a radiographic phase contrast image.

In the radiographic phase-contrast imaging apparatuses disclosed in Patent Documents 1 and 2, a fringe scanning method is carried out, where the second grating is positioned approximately parallel to the plane of the first grating, and a plurality of imaging operations are carried out to take a plurality of images with shifting (translating) the first grating or the second grating relative to each other by a predetermined distance, which is finer than the grating pitch, in a direction approximately orthogonal to the direction of the grating each time the grating, and an amount of phase variation (phase shift differential) of the X-ray caused by interaction with a subject is obtained based on the plurality of images. Then, a phase contrast image of the subject can be obtained based on the phase shift differential.

With the radiographic phase-contrast imaging apparatuses disclosed in Patent Documents 1 and 2, however, only phase information with respect to the direction orthogonal to the direction of the grating can be obtained, and therefore it is impossible to obtain a phase contrast image with sufficient image quality.

Further, with respect to a radiographic phase-contrast imaging apparatus disclosed in U.S. Patent Application Publication No. 20110158493 (which will hereinafter be referred to as Patent Document 3), it is proposed to obtain two-dimensional phase information by using gratings with a lot of crosses or dots arranged therein. However, these gratings are required to have a very narrow pitch, and production thereof is very difficult. For example, in a case of a grating with a lot of crosses arranged thereon, corners of rectangular areas formed by the crosses are not sharp, and this results in degraded spatial frequency information and degraded image quality.

On the other hand, with respect to the radiographic phase-contrast imaging apparatuses disclosed in Patent Documents 1 and 2, it is necessary to accurately shift the first or second grating at a pitch finer than the grating pitch thereof. The grating pitch is typically several micrometers, and even higher accuracy is required for shifting the grating. This requires a highly accurate shifting mechanism, resulting in a complicated mechanism and increase of costs. Further, in the case where imaging is carried out each time the grating is shifted, a positional relationship between the subject and the imaging system may be altered during a series of imaging operations to obtain a phase contrast image due to movement of the subject or vibration of the apparatus. In this case, it is impossible to correctly derive the phase variation of the X-ray caused by interaction with the subject, and therefore it is impossible to obtain a good phase contrast image.

### SUMMARY OF THE INVENTION

In view of the above-described circumstances, the present invention is directed to providing a radiographic imaging apparatus, with which a high quality phase contrast image having two-dimensional phase information can be obtained, and a radiographic image detector for use with the radiographic imaging apparatus.

The present invention is also directed to providing a radiographic imaging apparatus and a radiographic image detector, with which the above-described phase contrast image with two-dimensional phase information can be obtained in a single imaging operation.

An aspect of the radiographic imaging apparatus of the invention is a radiographic imaging apparatus including: a first grating having a periodically arranged grating structure and allowing radiation emitted from a radiation source to pass therethrough to form a first periodic pattern image; a second grating having a periodically arranged grating structure to receive the first periodic pattern image and form a second periodic pattern image; a radiographic image detector including two-dimensionally arranged pixel sections to detect the second periodic pattern image formed by the second grating; and an image generation unit to generate a phase contrast image based on the image signal representing the second periodic pattern image detected by the radiographic image detector, wherein one of the first grating and the second grating includes a plurality of unit gratings arranged in a predetermined range corresponding to each pixel forming the phase contrast image, wherein the unit gratings are formed by sets of unit grating members extending in different directions from each other, and the image generation unit generates a pixel signal of each pixel of the phase contrast image based on a plurality of detection signals detected by the pixel sections corresponding to the unit gratings in the predetermined range.

In the radiographic imaging apparatus of the invention, the other of the gratings may include a plurality of sub-unit gratings arranged therein, each sub-unit grating may be formed by a unit smaller than the unit grating and corresponding to each pixel section, and the sub-unit gratings in a range corresponding to each unit grating maybe arranged with being parallel shifted by different distances relative to the unit grating in a direction orthogonal to a direction in which the unit grating extends, and the image generation unit may generate a detection signal of each unit grating based on detection signals detected by the pixel sections corresponding to the sub-unit gratings arranged in the range corresponding to the unit grating.

In the apparatus of the invention, the first grating may include the plurality of unit gratings arranged therein and the second grating may include the plurality of sub-unit gratings arranged therein, and the sub-unit gratings in the range corresponding to each unit grating of the first grating may be arranged with being parallel shifted by different distances in increments of P/M. relative to the image of the first grating, where P is a pitch of the second grating and M is a number of pieces of phase information set in advance to be used to generate each pixel forming the phase contrast image.

In the apparatus of the invention, the second grating may include the plurality of unit gratings arranged therein and the first grating may include the plurality of sub-unit gratings arranged therein, and images of the sub-unit gratings in the range corresponding to each unit grating of the second grating may be arranged with being parallel shifted by different distances in increments of P/M. relative to the second grating, where P is a pitch of the second grating and M is a number of pieces of phase information set in advance to be used to generate each pixel forming the phase contrast image.

In the apparatus of the invention, the unit gratings may be formed by sets of unit grating members extending in directions orthogonal to each other.

In the apparatus of the invention, the unit gratings in the predetermined range may be arranged in an alternating pattern.

In the apparatus of the invention, the unit gratings arranged in the predetermined range may include different types of unit gratings having an equal area ratio in the predetermined range.

In the apparatus of the invention, the unit gratings arranged in the predetermined range may include two or more unit gratings formed by the unit grating members extending in the same direction, wherein the two or more unit gratings have different arrangement pitches of the unit grating members from each other.

In the apparatus of the invention, the sub-unit gratings arranged in the range corresponding to each unit grating may include different types of sub-unit gratings with different arrangement pitches.

In the apparatus of the invention, the second grating may be positioned at a Talbot interference distance from the first grating and may apply intensity modulation to the first periodic pattern image of the first grating formed by the Talbot interference effect.

In the apparatus of the invention, the first grating may be an absorption type grating and may allow the radiation to pass therethrough as a projection image to form the first periodic pattern image, and the second grating may apply intensity modulation to the first periodic pattern image which is the projection image passed through the first grating.

In the apparatus of the invention, the second grating may be positioned at a distance shorter than a minimum Talbot interference distance from the first grating.

Another aspect of the radiographic imaging apparatus of the invention is a radiographic imaging apparatus including: a grating having a periodically arranged grating structure and allowing radiation emitted from a radiation source to pass therethrough to form a periodic pattern image; a radiographic image detector including a first electrode layer transmitting therethrough the periodic pattern image formed by the grating, a photoconductive layer to generate electric charges when exposed to the periodic pattern image transmitted through the first electrode layer, an electric charge storing layer to store the electric charges generated at the photoconductive layer, and a second electrode layer including a lot of linear electrodes transmitting reading light therethrough, the layers being formed in this order, wherein a detection signal of each pixel section corresponding to each linear electrode is read out by scanning with the reading light; and an image generation unit to generate a phase contrast image based on an image signal representing the periodic pattern image detected by the radiographic image detector, wherein the electric charge storing layer has a grating pattern with a pitch finer than an arrangement pitch of the linear electrodes, the grating includes a plurality of unit gratings arranged in a predetermined range corresponding to each pixel forming the phase contrast image, wherein the unit gratings are formed by sets of unit grating members extending in different directions from each other, and the image generation unit generates a pixel signal of each pixel of the phase contrast image based on a plurality of detection signals detected by the pixel sections corresponding to the unit gratings in the predetermined range.

In the radiographic imaging apparatus of the invention, the electric charge storing layer may include a plurality of sub-unit grating patterns arranged therein, each sub-unit grating pattern may be formed by a unit smaller than the unit grating and corresponding to each pixel section, and the sub-unit grating patterns in a range corresponding to each unit grating may be arranged with being parallel shifted by different distances relative to the unit grating in a direction orthogonal to a direction in which the unit grating extends, and the image generation unit may generate a detection signal of each unit grating based on detection signals detected by the pixel sections corresponding to the sub-unit gratings arranged in the range corresponding to the unit grating.

In the apparatus of the invention, the sub-unit grating patterns in the range corresponding to each unit grating of the grating may be arranged with being parallel shifted by different distances in increments of P/M relative to the image of the grating, where P is a pitch of the sub-unit grating patterns and M is a number of pieces of phase information set in advance to be used to generate each pixel forming the phase contrast image.

In the apparatus of the invention, the unit gratings may be formed by sets of unit grating members extending in directions orthogonal to each other.

In the apparatus of the invention, the unit gratings in the predetermined range may be arranged in an alternating pattern.

In the apparatus of the invention, the unit gratings arranged in the predetermined range may include different types of unit gratings having an equal area ratio in the predetermined range.

In the apparatus of the invention, the unit gratings arranged in the predetermined range may include two or more unit gratings formed by the unit grating members extending in the same direction, wherein the two or more unit gratings have different arrangement pitches of the unit grating members from each other.

In the apparatus of the invention, the sub-unit grating patterns arranged in the range corresponding to each unit grating may include different types of sub-unit gratings with different arrangement pitches.

In the apparatus of the invention, the radiographic image detector may be positioned at a Talbot interference distance from the grating and may apply intensity modulation to the periodic pattern image of the grating formed by the Talbot interference effect.

In the apparatus of the invention, the grating may be an absorption type grating and may allow the radiation to pass therethrough as a projection image to form the periodic pattern image, and the radiographic image detector may apply intensity modulation to the periodic pattern image which is the projection image passed through the grating.

In the apparatus of the invention, the radiographic image detector may be positioned at a distance shorter than a minimum Talbot interference distance from the grating.

Yet another aspect of the radiographic imaging apparatus of the invention is a radiographic imaging apparatus including: a grating having a periodically arranged grating structure and allowing radiation emitted from a radiation source to pass therethrough to form a periodic pattern image; a radiographic image detector including a first electrode layer transmitting therethrough the periodic pattern image formed by the grating, a photoconductive layer to generate electric charges when exposed to the periodic pattern image transmitted through the first electrode layer, an electric charge storing layer to store the electric charges generated at the photoconductive layer, and a second electrode layer including a lot of linear electrodes transmitting reading light therethrough, the layers being formed in this order, wherein a detection signal of each pixel section corresponding to each linear electrode is read out by scanning with the reading light; and an image generation unit to generate a phase contrast image based on an image signal representing the periodic pattern image detected by the radiographic image detector, wherein the electric charge storing layer includes a plurality of unit grating patterns arranged in a predetermined range corresponding to each pixel forming the phase contrast image, wherein the unit grating patterns are formed by sets of unit grating sections extending in different directions from each other, and the image generation unit generates a pixel signal of each pixel of the phase contrast image based on a plurality of detection signals detected by the pixel sections corresponding to the unit grating patterns in the predetermined range.

In the radiographic imaging apparatus of the invention, the grating may include a plurality of sub-unit gratings arranged therein, each sub-unit grating may be formed by a unit smaller than the unit grating pattern and corresponding to each pixel section, and the sub-unit gratings in a range corresponding to each unit grating pattern may be arranged with being parallel shifted by different distances relative to the unit grating pattern in a direction orthogonal to a direction in which the unit grating pattern extends, and the image generation unit may generate a detection signal of each unit grating pattern based on detection signals detected by the pixel sections corresponding to the sub-unit gratings arranged in the range corresponding to the unit grating pattern.

In the apparatus of the invention, images of the sub-unit gratings in the range corresponding to each unit grating pattern of the electric charge storing layer may be arranged with being parallel shifted by different distances in increments of P/M relative to the unit grating pattern, where P is a pitch of the unit grating pattern and M is a number of pieces of phase information set in advance to be used to generate each pixel forming the phase contrast image.

In the apparatus of the invention, the unit grating patterns may be formed by sets of unit grating sections extending in directions orthogonal to each other.

In the apparatus of the invention, the unit grating patterns in the predetermined range may be arranged in an alternating pattern.

In the apparatus of the invention, the unit grating patterns arranged in the predetermined range may include different types of unit grating patterns having an equal area ratio in the predetermined range.

In the apparatus of the invention, the unit grating patterns arranged in the predetermined range may include two or more unit grating patterns formed by the unit grating sections extending in the same direction, wherein the two or more unit grating patterns may have different arrangement pitches of the unit grating sections from each other.

In the apparatus of the invention, the sub-unit gratings arranged in the range corresponding to each unit grating pattern may include different types of sub-unit gratings with different arrangement pitches.

In the apparatus of the invention, the radiographic image detector may be positioned at a Talbot interference distance from the grating and may apply intensity modulation to the periodic pattern image of the grating formed by the Talbot interference effect.

In the apparatus of the invention, the grating may be an absorption type grating and may allow the radiation to pass therethrough as a projection image to form the periodic pattern image, and the radiographic image detector may apply intensity modulation to the periodic pattern image which is the projection image passed through the grating.

In the apparatus of the invention, the radiographic image detector may be positioned at a distance shorter than a minimum Talbot interference distance from the grating.

An aspect of the radiographic image detector of the invention is a radiographic image detector including: a first electrode layer transmitting radiation; a photoconductive layer to generate electric charges when exposed to the radiation transmitted through the first electrode layer; an electric charge storing layer to store the electric charges generated at the photoconductive layer; and a second electrode layer including a lot of linear electrodes transmitting reading light therethrough, the layers being formed in this order, wherein a detection signal of each pixel section corresponding to each linear electrode is read out by scanning with the reading light, wherein the electric charge storing layer includes a plurality of unit grating patterns arranged in a predetermined range, wherein the unit grating patterns are formed by sets of unit grating sections extending in different directions from each other.

According to the radiographic imaging apparatus of the invention, one of the first grating and the second grating includes a plurality of unit gratings arranged in a predetermined range corresponding to each pixel forming the phase contrast image, wherein the unit gratings are formed by sets of unit grating members extending in different directions from each other, and a pixel signal of each pixel of the phase contrast image is generated based on a plurality of detection signals detected by the pixel sections corresponding to the unit gratings in the predetermined range. Therefore, a high quality phase contrast image having two-dimensional information can be obtained without using the conventional grating having crosses or dots, as described above.

In the case where the other of the gratings includes a plurality of sub-unit gratings arranged therein, where each sub-unit grating is formed by a unit smaller than the unit grating and corresponding to each pixel section and the sub-unit gratings in a range corresponding to each unit grating are arranged with being parallel shifted by different distances relative to the unit grating in a direction orthogonal to a direction in which the unit grating extends, and a detection signal of each unit grating is generated based on detection signals detected by the pixel sections corresponding to the sub-unit gratings arranged in the range corresponding to the unit grating, detection signals with different types of phase information can be obtained in a single imaging operation without need of a highly accurate shifting mechanism to shift the second grating as in prior art apparatuses, and thus a phase contrast image can be obtained in a single imaging operation.

In the case where the unit gratings in the predetermined range are arranged in an alternating pattern, phase information in the predetermined range with respect to different directions can be obtained in a well-balanced manner.

Also, in the case where the unit gratings arranged in the predetermined range include different types of unit gratings having an equal area ratio in the predetermined range, phase information in the predetermined range with respect to different directions can be obtained in a well-balanced manner.

In the case where the unit gratings arranged in the predetermined range include two or more unit gratings formed by the unit grating members extending in the same direction, wherein the two or more unit gratings have different arrangement pitches of the unit grating members from each other, detection signals with different types of frequency information can be obtained, and an energy subtraction phase contrast image can be obtained by calculating a difference between the different types of frequency information, for example.

Also, in the case where the sub-unit gratings arranged in the range corresponding to each unit grating include different types of sub-unit gratings with different arrangement pitches, detection signals with different types of frequency information can be obtained.

Further, the electric charge storing layer of the radiographic image detector may have a grating pattern to provide the radiographic image detector with the function of the second grating. In this case, the grating, which needs to be formed to have a high aspect ratio and thus is difficult to be produced, may not be provided, and this facilitates the manufacture of the radiographic image detector.

### BRIEF DESCRIPTION OF THE DRAWINGS

FIG. 1 is a diagram illustrating the schematic configuration of a radiographic phase-contrast imaging apparatus according to a first embodiment of the present invention,

FIG. 2 is a plan view of the radiographic phase-contrast imaging apparatus shown in FIG. 1,

FIG. 3 is a diagram illustrating one example of a two-dimensional grating of a radiation emission unit,

FIG. 4 is an enlarged partial view of a first grating,

FIG. 5 is an enlarged partial view of a second grating,

FIG. 6 is a diagram illustrating a positional relationship between a self image of each unit grating and sub-unit gratings forming the second grating,

FIG. 7 is a diagram illustrating the schematic structure of a radiographic image detector of a TFT reading system,

FIG. 8 is a diagram illustrating an example of one radiation path which is refracted depending on a phase shift distribution Φ(x) of a subject with respect to an X-direction,

FIG. 9 is a diagram for explaining how a phase contrast image is generated,

FIG. 10 is a diagram illustrating another arrangement of sub-unit gratings correspond to a range of each unit grating,

FIG. 11 is a diagram illustrating the schematic structure of a radiographic image detector of an optical reading system,

FIG. 12 is a diagram for explaining an operation of recording with the radiographic image detector shown in FIG. 11,

FIG. 13 is a diagram for explaining an operation of reading from the radiographic image detector shown in FIG. 11,

FIG. 14 is a diagram for explaining how an absorption image and a small-angle scattering image are generated,

FIG. 15 is a diagram illustrating the schematic structure of one embodiment of a radiographic image detector having a function of the second grating,

FIG. 16 is a diagram illustrating one example of sub-unit grating patterns of electric charge storing layer in the radiographic image detector shown in FIG. 15,

FIG. 17 is a diagram for explaining an operation of recording with the radiographic image detector shown in FIG. 15,

FIG. 18 is a diagram for explaining an operation of reading from the radiographic image detector shown in FIG. 15,

FIG. 19 is a diagram illustrating the schematic structure of another embodiment of the radiographic image detector having the function of the second grating,

FIG. 20 is a diagram for explaining an operation of recording with the radiographic image detector shown in FIG. 19,

FIG. 21 is a diagram for explaining an operation of reading from the radiographic image detector shown in FIG. 19, and

FIG. 22 is a diagram illustrating the schematic structure of yet another embodiment of the radiographic image detector having the function of the second grating.

### DESCRIPTION OF THE PREFERRED EMBODIMENTS

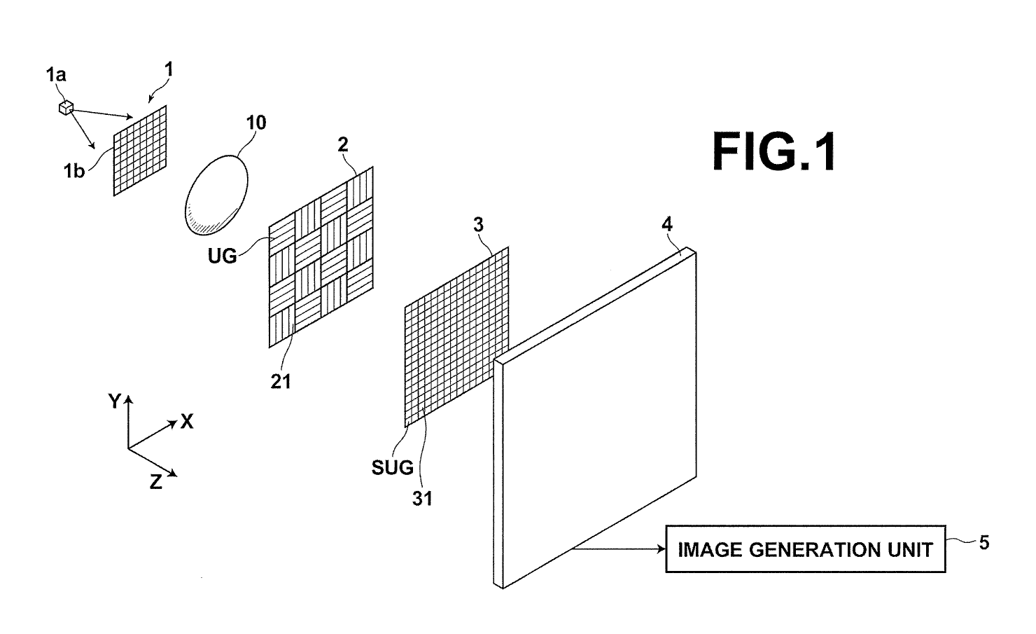

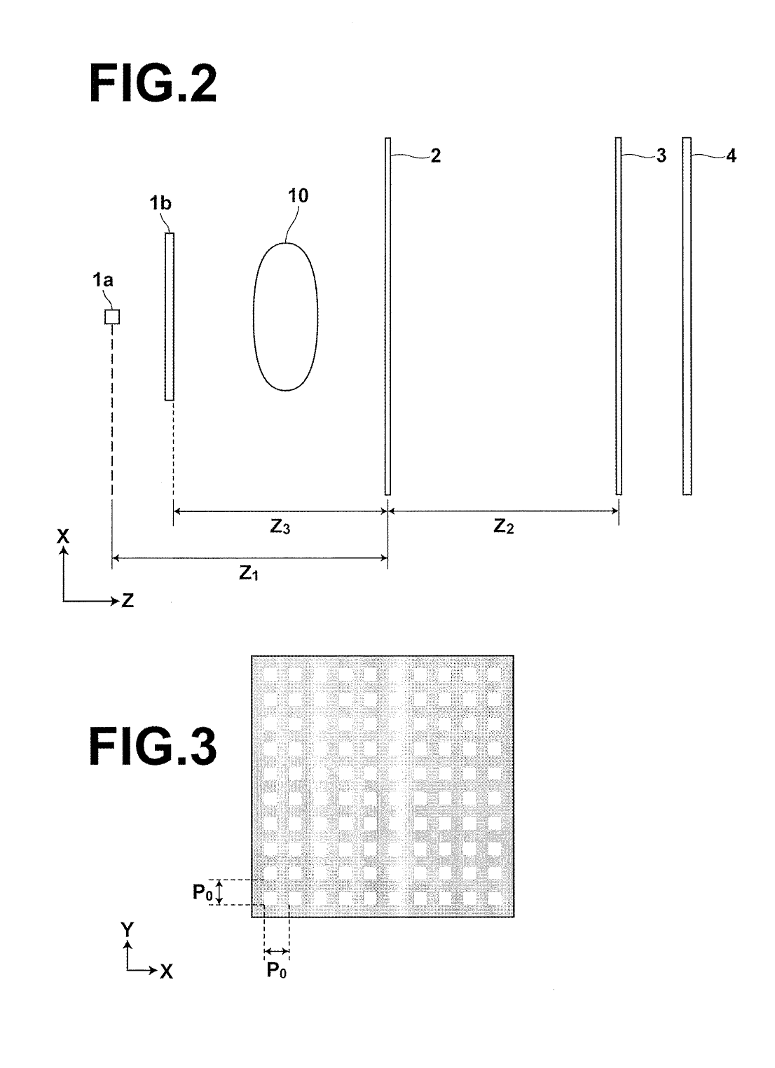

Hereinafter, a radiographic phase-contrast imaging apparatus employing a first embodiment of a radiographic imaging apparatus of the present invention will be described with reference to the drawings. FIG. 1 shows the schematic configuration of the radiographic phase-contrast imaging apparatus according to the first embodiment. FIG. 2 shows a plan view (a sectional view taken along the X-Z plane) of the radiographic phase-contrast imaging apparatus shown in FIG. 1. The direction perpendicular to the plane of FIG. 2 corresponds to the Y-direction in FIG. 1.

As shown in FIG. 1, the radiographic phase-contrast imaging apparatus includes: a radiation emission unit 1 to emit radiation toward a subject 10; a first grating 2 allowing the radiation emitted from the radiation emission unit 1 to pass therethrough to form a first periodic pattern image; a second grating 3 to apply intensity modulation to the first periodic pattern image formed by the first grating 2 to form a second periodic pattern image; a radiographic image detector 4 to detect the second periodic pattern image formed by the second grating 3; and an image generation unit 5 to obtain an image signal based on the second periodic pattern image detected by the radiographic image detector 4 and to generate a phase contrast image based on the obtained image signal.

The radiation emission unit 1 includes a radiation source la, which emits radiation toward the subject 10, and a two-dimensional grating 1b including areas transmitting the radiation emitted from the radiation source la and areas shielding the radiation. The spatial coherence of the radiation is such that the Talbot interference effect occurs when the radiation is applied to the first grating 2.

As shown in FIG. 3, the two-dimensional grating 1b is a two-dimensional radiation absorption grating, where radiation shielding sections extending in the X-direction are periodically arranged along the Y-direction and radiation shielding sections extending in the Y-direction are periodically arranged along the X-direction. The two-dimensional grating 1b can reduce an effective focal spot size relative to the X-direction and the Y-direction by partially shielding the radiation emitted from the focal spot of the radiation source 1, and can form a lot of microfocus light sources in the X-direction and the Y-direction. In a case where the radiation source 1a is capable of emitting coherent parallel light (such as a radiation, microfocus X-ray source), the two-dimensional grating 1b is not necessary.

It is necessary to determine a grating pitch P₀ of the two-dimensional grating 1b to satisfy Expression (1) below:

P₀P₂×Z₃/Z₂ (1)

where P₂ is a pitch of the second grating 3, Z₃ is a distance from the two-dimensional grating 1b to the first grating 2, and Z₂ is a distance from the first grating 2 to the second grating 3.

As shown in FIG. 1, the first grating 2 includes a substrate 21, which mainly transmits radiation, and a lot of unit gratings UG disposed on the substrate 21.

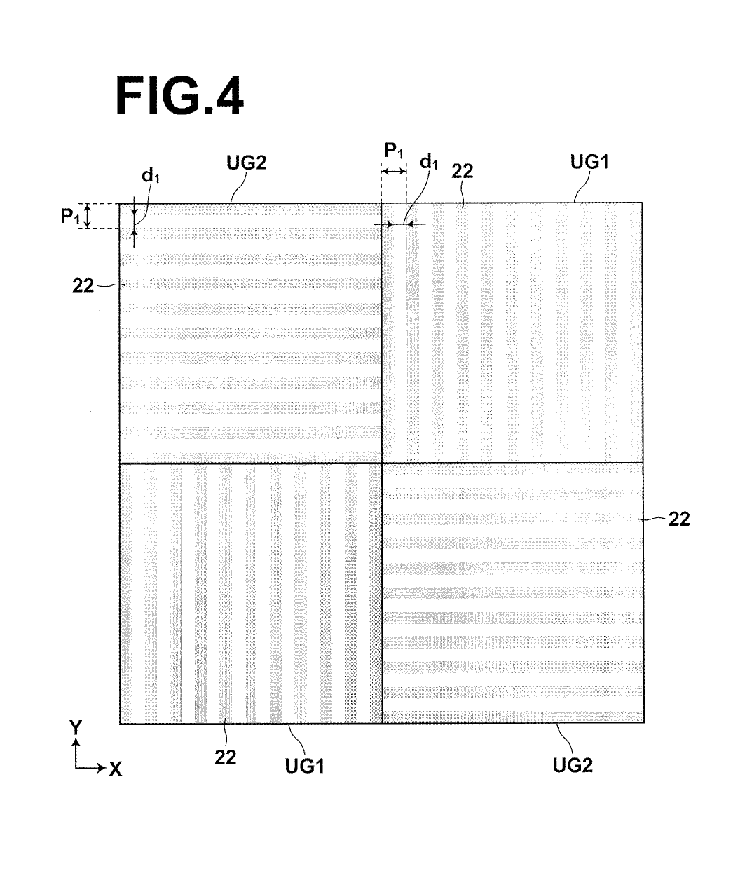

FIG. 4 shows an enlarged partial view of the first grating 2 shown in FIG. 1. As shown in FIG. 4, the first grating 2 includes: first unit gratings UG1, which have a lot of rectangular unit grating members 22 extending in the Y-direction and arranged along the X-direction; and second unit gratings UG2, which have a lot of rectangular unit grating members 22 extending in the X-direction, which is orthogonal to the Y-direction, and arranged along the Y-direction. In this embodiment, the first unit gratings UG1 and the second unit gratings UG2 are alternately arranged along the X-direction and the Y-direction to form an alternating pattern.

The material forming the unit grating members 22 may be a metal, such as gold or platinum. It is desirable that the first grating 2 is a so-called phase modulation grating, which applies phase modulation of about 90° or about 180° to the radiation applied thereto. If the unit grating members 22 are made of gold, for example, the necessary thickness in the Z-direction of the unit grating members 22 for an X-ray energy region for usual medical diagnosis is on the order of 1 μm to 10 μm. Alternatively, an amplitude modulation grating maybe used. In this case, the unit grating members 22 need to have a thickness for sufficiently absorbing the radiation. If the unit grating members 22 are made of gold, for example, the necessary thickness of the unit grating members 22 for an X-ray energy region for usual medical diagnosis is on the order of ten micrometers to several hundreds micrometers.

In this embodiment, the range of the four unit gratings shown in FIG. 4 corresponds to one pixel of the phase contrast image. That is, a pixel signal of each pixel of the phase contrast image is generated by using two sets of unit gratings, each including the first unit grating UG1 and the second unit grating UG2 adjacent to each other. Although FIG. 4 shows only the four unit gratings corresponding to one pixel of the phase contrast image, actually, the four unit gratings shown in FIG. 4 are repeatedly arranged along the X-direction and the Y-direction.

As shown in FIG. 1, the second grating 3 includes, similarly to the first grating 2, a substrate 31, which mainly transmits the radiation, and a lot of sub-unit gratings SUG disposed on the substrate 31.

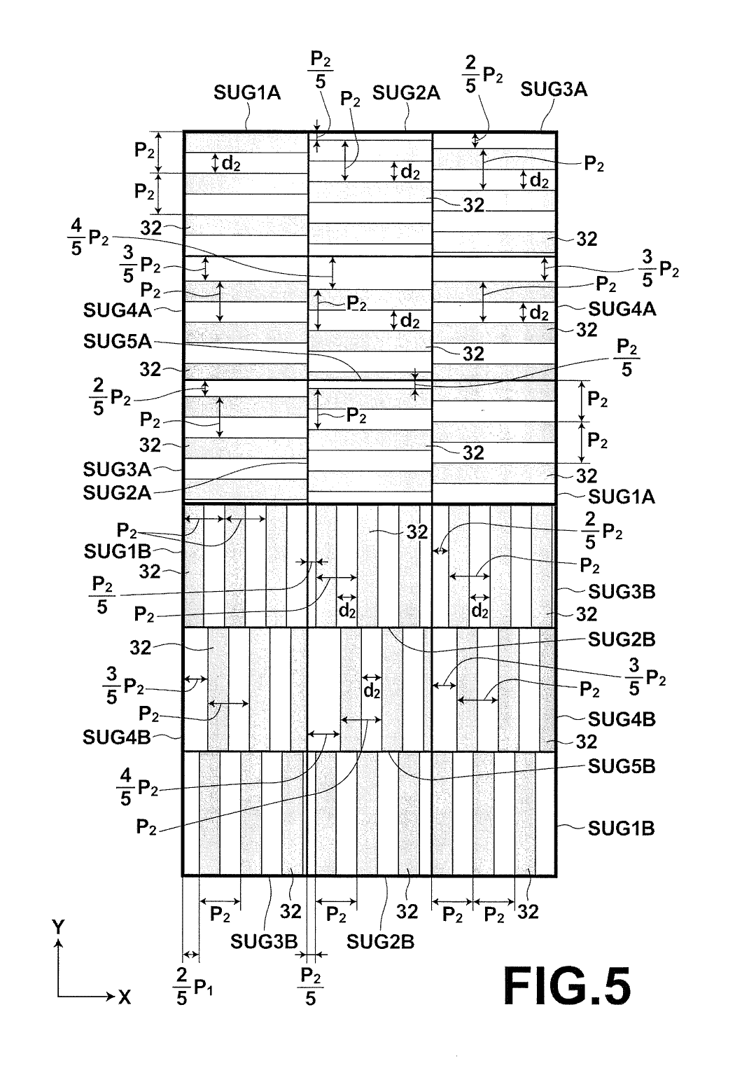

FIG. 5 is an enlarged partial view of the second grating 3 shown in FIG. 1. Upper nine sub-unit gratings SUG1A to SUG5A surrounded by the heavy line in FIG. 5 correspond to the range of the upper-left second unit grating UG2 shown in FIG. 4, and lower nine sub-unit gratings SUG1B to SUG5B correspond to the range of the lower-left first unit grating UG1 shown in FIG. 4. That is, a self image G2 of the second unit grating UG2, which is formed when the radiation is transmitted through the upper-left second unit grating UG2 shown in FIG. 4, is applied onto the upper nine sub-unit gratings SUG1A to SUG5A shown in FIG. 5, and a self image G1 of the first unit grating UG1, which is formed when the radiation is transmitted through the lower-left first unit grating UG1 shown in FIG. 4, is applied onto the lower nine sub-unit gratings SUG1B to SUG5B shown in FIG. 5.

FIG. 5 only shows the sub-unit gratings corresponding to the left two unit gratings shown in FIG. 4. Sub-unit gratings corresponding to the right two unit gratings shown in FIG. 4 are arranged such that the upper nine sub-unit gratings shown in FIG. 5 are positioned at the lower side and the lower nine sub-unit gratings shown in FIG. 5 are positioned at the upper side. Then, a set of four sub-unit gratings, which includes the set of two sub-unit gratings shown in FIG. 5 and a set of two sub-unit gratings having an opposite positional relationship between the sub-unit gratings from that shown in FIG. 5 are repeatedly arranged along the X-direction and the Y-direction. Then, a pixel signal of one pixel of the phase contrast image is generated by using the set of four sub-unit gratings.

Each of the upper sub-unit gratings SUG1A to SUG5A shown in FIG. 5 is formed by arranging, along the Y-direction, a lot of rectangular sub-unit grating members 32 extending in the X-direction. The upper nine sub-unit gratings shown in FIG. 5 include two sub-unit gratings SUG1A, two sub-unit gratings SUG2A, two sub-unit gratings SUG3A, two sub-unit gratings SUG4A and one sub-unit grating SUG5A. Each set of the sub-unit grating members 32 forming each sub-unit grating SUG1A, SUG2A, SUG3A, SUG4A or SUG5A is offset from the other sets of the sub-unit grating members 32 forming the other sub-unit gratings by different distances in increments of a predetermined pitch in the Y-direction. The configuration of the sub-unit gratings SUG1A to SUG5A will be described in detail later.

Each of the lower sub-unit gratings SUG1B to SUG5B shown in FIG. 5 is formed by arranging, along the X-direction, a lot of rectangular sub-unit grating members 32 extending in the Y-direction. The lower nine sub-unit gratings shown in FIG. 5 include two sub-unit gratings SUG1B, two sub-unit gratings SUG2B, two sub-unit gratings SUG3B, two sub-unit gratings SUG4B and one sub-unit grating SUG5B. Each set of the sub-unit grating members 32 forming each sub-unit grating SUG1B, SUG2B, SUG3B, SUG4B or SUG5B is offset from the other sets of the sub-unit grating members 32 forming the other sub-unit gratings by different distances in increments of a predetermined pitch in the X-direction. The configuration of the sub-unit gratings SUG1B to SUG5B will be described in detail later.

The material forming the sub-unit grating members 32 may be a metal, such as gold or platinum. It is desirable that the second grating 3 is an amplitude modulation grating. In this case, the sub-unit grating members 32 need to have a thickness for sufficiently absorbing the radiation. If the sub-unit grating members 32 are made of gold, for example, the necessary thickness of the sub-unit grating members 32 for an X-ray energy region for usual medical diagnosis is on the order of ten micrometers to several hundreds micrometers.

In this embodiment, pieces of phase information which are different from each other are obtained based on the second periodic pattern image detected by the radiographic image detector 4, and the phase contrast image is generated based on the pieces of phase information. It is assumed here that five pieces of phase information are generated based on the second periodic pattern image, and the phase contrast image is generated based on the five pieces of phase information.

Now, the detailed configuration of the first and second gratings 2 and 3 for generating the five pieces of phase information are described.

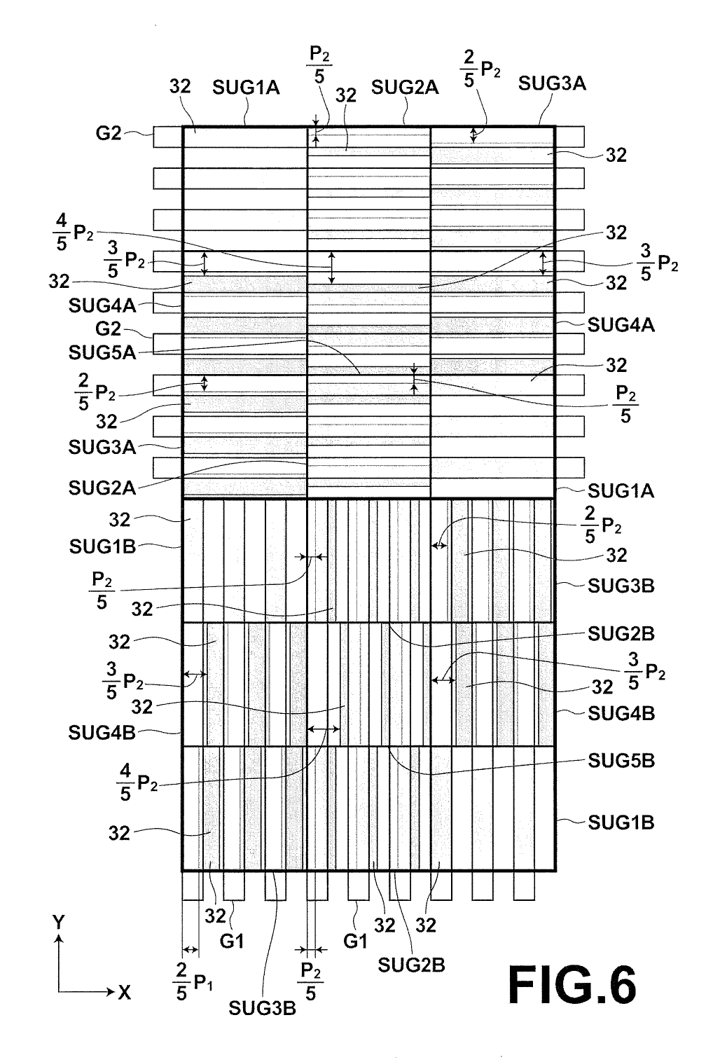

FIG. 6 is a diagram illustrating a positional relationship between the self images G1 and G2, which are formed at a position of the second grating 3 when the radiation is transmitted through the first and second unit gratings UG1 and UG2 on the left shown in FIG. 4, and the sub-unit grating members 32 of the sub-unit gratings SUG1A to SUG5A and SUG1B to SUG5B shown in FIG. 5. In FIG. 6, the length of the self images G1 and G2 is longer than the actual length for facilitating understanding. The actual length of the self images G1 and G2 is a length within each range surrounded by the heavy line shown in FIG. 6.

As shown in FIG. 6, the five types of sub-unit gratings SUG1A to SUG5A are arranged at different distances in the Y-direction from the self image G2 of the second unit grating UG2. Specifically, the sub-unit grating members 32 of the sub-unit grating SUG1A are arranged at an arrangement pitch P₂ with a distance of 0 from the self image G2, the sub-unit grating members 32 of the sub-unit grating SUG2A are arranged at the arrangement pitch P₂ with a distance of P₂/5 from the self image G2, the sub-unit grating members 32 of the sub-unit grating SUG3A are arranged at the arrangement pitch P₂ with a distance of (2×P₂) /5 from the self image G2, the sub-unit grating members 32 of the sub-unit grating SUG4A are arranged at the arrangement pitch P₂ with a distance of (3×P₂) /5 from the self image G2, and the sub-unit grating members 32 of the sub-unit grating SUG5A are arranged at the arrangement pitch P₂ with a distance of (4×P₂) /5 from the self image G2. The interval between the sub-unit grating members 32 is d₂.

Then, the self image G2 of the second unit grating UG2 transmitted through the five types of sub-unit gratings SUG1A to SUG5A, which are configured as shown in FIG. 6, is detected by each pixel circuit 40, which will be described later, of the radiographic image detector 4 to obtain detection signals of the five different pieces of phase information with respect to the Y-direction.

Further, as shown in FIG. 6, the five types of sub-unit gratings SUG1B to SUG5B are arranged at different distances in the X-direction from the self image G1 of the first unit grating UG1. Specifically, the sub-unit grating members 32 of the sub-unit grating SUG1B are arranged at the arrangement pitch P₂ with a distance of 0 from the self image G1, the sub-unit grating members 32 of the sub-unit grating SUG2B are arranged at the arrangement pitch P₂ with a distance of P₂/5 from the self image G1, the sub-unit grating members 32 of the sub-unit grating SUG3B are arranged at the arrangement pitch P₂ with a distance of (2×P₂) /5 from the self image G1, the sub-unit grating members 32 of the sub-unit grating SUG4B are arranged at the arrangement pitch P₂ with a distance of (3×P₂) /5 from the self image G1, and the sub-unit grating members 32 of the sub-unit grating SUG5B are arranged at the arrangement pitch P₂ with a distance of (4×P₂) /5 from the self image G1. The interval between the sub-unit grating members 32 is d₂.

Then, the self image G1 of the first unit grating UG1 transmitted through the five types of sub-unit gratings SUG1B to SUG5B, which are configured as shown in FIG. 6, is detected by each pixel circuit 40, which will be described later, of the radiographic image detector 4 to obtain detection signals of the five different pieces of phase information with respect to the X-direction.

A method for generating each pixel signal of the phase contrast image based on the detection signals of the five different pieces of phase information with respect to the X-direction and the detection signals of the five different pieces of phase information with respect to the Y-direction, which are obtained as described above, will be described in detail later.

In a case where the radiation emitted from the radiation emission unit 1 is not a parallel beam but a cone beam, the self images G1 and G2 of the first grating 2 formed by the radiation passed through the first grating 2 are magnified in proportion to the distance from the radiation emission unit 1. Therefore, assuming that the distance from the focal spot of the radiation source 1 to the first grating 2 is Z₁ and the distance from the first grating 2 to the second grating 3 is Z₂, as shown in FIG. 2, the pitch P₁ of the first and second unit gratings UG1 and UG2 shown in FIG. 4 and the pitch P₂ of the sub-unit gratings SUG1A to SUG5A and SUG1B to SUG5B shown in FIGS. 5 and 6 are determined to satisfy the relationship defined as Expression (2) below:

$${P}_{2} = {P}_{1}^{′} = \frac{{Z}_{1} + {Z}_{2}}{{Z}_{1}} {P}_{1} \qquad ( 2 )$$

where P₁′ is a pitch of the self images G1 and G2 of the first and second unit gratings UG1 and UG2 at the position of the second grating 3.

Alternatively, in the case where the first grating 2 is a phase modulation grating that applies phase modulation of 180°, the pitches P₁ and P₂ are determined to satisfy the relationship defined as Expression (3) below:

$${P}_{2} = {P}_{1}^{′} = \frac{{Z}_{1} + {Z}_{2}}{{Z}_{1}} \cdot \frac{{P}_{1}}{2} \qquad ( 3 )$$

It should be noted that, in a case where the radiation emitted from the radiation emission unit 1 is a parallel beam, if the first grating 2 is a 90° phase modulation grating or an amplitude modulation grating, the pitches P₁ and P₂ are determined to satisfy:

P₂=P₁,

or if the first grating 2 is a 180° phase modulation grating, the pitches P₁and P₂ are determined to satisfy:

P₂=P₁/2.

Then, the radiographic phase-contrast imaging apparatus, which can obtain a phase contrast image with the radiation emission unit 1, the first grating 2, the second grating 3 and the radiographic image detector 4, as described above, is formed. In order to make this configuration function as a Talbot interferometer, some more conditions must almost be satisfied. Now, the conditions are described.

First, it is necessary that grid planes of the first grating 2 and the second grating 3 are parallel to the X-Y plane shown in FIG. 1.

Further, if the first grating 2 is a phase modulation grating that applies phase modulation of 90°, then, the distance Z₂ between the first grating 2 and the second grating 3 must almost satisfy the condition below:

$${Z}_{2} = ( m + \frac{1}{2} ) \frac{{P}_{1} {P}_{2}}{λ} \qquad ( 4 )$$

where λ is the wavelength of the radiation (which is typically the effective wavelength), m is 0 or a positive integer, P₁ is the above-described arrangement pitch of the unit grating members 22 of the first grating 2, and P₂ is the above-described arrangement pitch of the sub-unit grating members 32 of the second grating 3.

Alternatively, if the first grating 2 is a phase modulation grating that applies phase modulation of 180°, then, the distance Z₂ between the first grating 2 and the second grating 3 must almost satisfy the condition below:

$${Z}_{2} = ( m + \frac{1}{2} ) \frac{{P}_{1} {P}_{2}}{2 λ} \qquad ( 5 )$$

where λ is the wavelength of the radiation (which is typically the effective wavelength), m is 0 or a positive integer, P₁ is the above-described arrangement pitch of the unit grating members 22 of the first grating 2, and P₂ is the above-described arrangement pitch of the sub-unit grating members 32 of the second grating 3.

Still alternatively, if the first grating 2 is an amplitude modulation grating, then, the distance Z₂ between the first grating 2 and the second grating 3 must almost satisfy the condition below:

$${Z}_{2} = {m}^{′} \frac{{P}_{1} {P}_{2}}{λ} \qquad ( 6 )$$

where λ is the wavelength of the radiation (which is typically the effective wavelength), m′ is a positive integer, P₁ is the above-described arrangement pitch of the unit grating members 22 of the first grating 2, and P₂ is the above-described arrangement pitch of the sub-unit grating members 32 of the second grating 3.

It should be noted that the above Expressions (4), (5) and (6) are used in the case where the radiation emitted from the radiation emission unit 1 is a cone beam. In the case where the radiation emitted from the radiation source 1 is a parallel beam, Expression (7) below is applied in place of Expression (4), Expression (8) below is applied in place of Expression (5), and Expression (9) below is applied in place of Expression (6):

$$\begin{matrix}{Z}_{2} = ( m + \frac{1}{2} ) \frac{{P}_{1}^{2}}{λ} & ( 7 ) \\ {Z}_{2} = ( m + \frac{1}{2} ) \frac{{P}_{1}^{2}}{4 λ} & ( 8 ) \\ {Z}_{2} = {m}^{′} \frac{{P}_{1}^{2}}{λ} & ( 9 )\end{matrix}$$

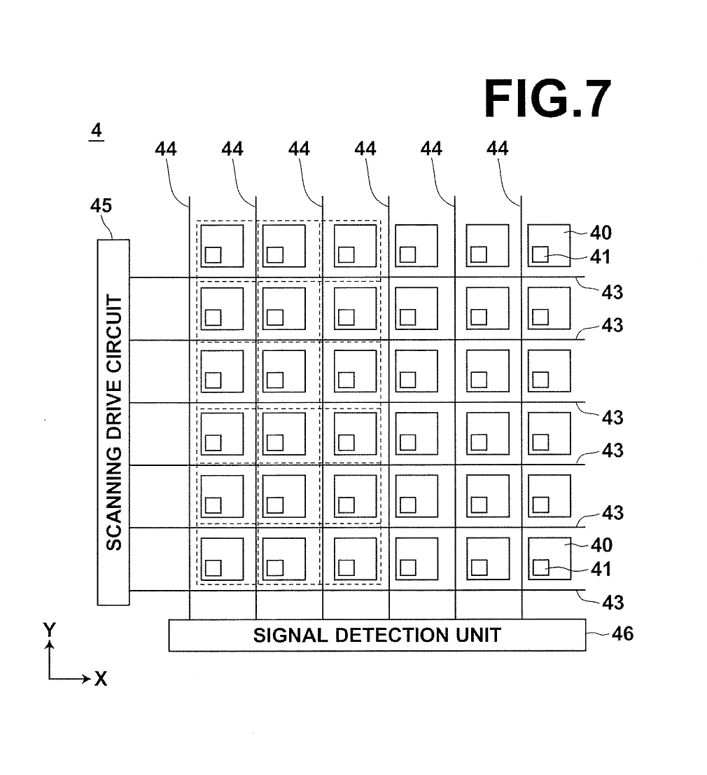

The radiographic image detector 4 detects an image provided by applying intensity modulation by the sub-unit gratings SUG1A to SUG5A and SUG1B to SUG5B of the second grating 3 to the self images G1 and G2 of the first and second unit gratings UG1 and UG2 of the first grating 2, which is formed by the radiation entering the first grating 2. In this embodiment, a radiographic image detector of a so-called TFT reading system, where a lot of pixel circuits 40 provided with TFT (thin film transistor) switches 41 are two-dimensionally arranged, as shown in FIG. 7, is used as the radiographic image detector 4.

The radiographic image detector 4 includes a lot of gate scanning lines 43, to which a scanning signal for turning on or off the TFT switch 41 of each pixel circuit 40 is outputted, and a lot of data lines 44, to which a pixel signal read out from each pixel circuit 40 via the TFT switch 41 is outputted. The gate scanning lines 43 and the data lines 44 are disposed orthogonal to each other. Each gate scanning line 43 is provided for each pixel circuit row and each data line 44 is provided for each pixel circuit column.

The gate scanning lines 43 are connected to a scanning drive circuit 45, which outputs the scanning signal for turning on or off the TFT switch 41 of each pixel circuit 40, and the data lines 44 are connected to a signal detection unit 46. The signal detection unit 46 detects a signal outputted from each pixel circuit 40 to the corresponding data line 44 and outputs the detected signal to the image generation unit 5.

As described above, in this embodiment, four unit gratings of the first grating 2 are assigned to each pixel forming the phase contrast image, nine sub-unit gratings are assigned to each unit grating, and one pixel circuit 40 is assigned to each sub-unit grating. Therefore, the number of the pixel circuits 40 used to generate a pixel signal of each pixel of the phase contrast image is 9×4=36. The eighteen pixel circuits 40 indicated by the squares of dashed lines in FIG. 7 correspond to the nine sub-unit gratings SUG1A to SUG5A and the nine sub-unit gratings SUG1B to SUG5B shown in FIG. 6.

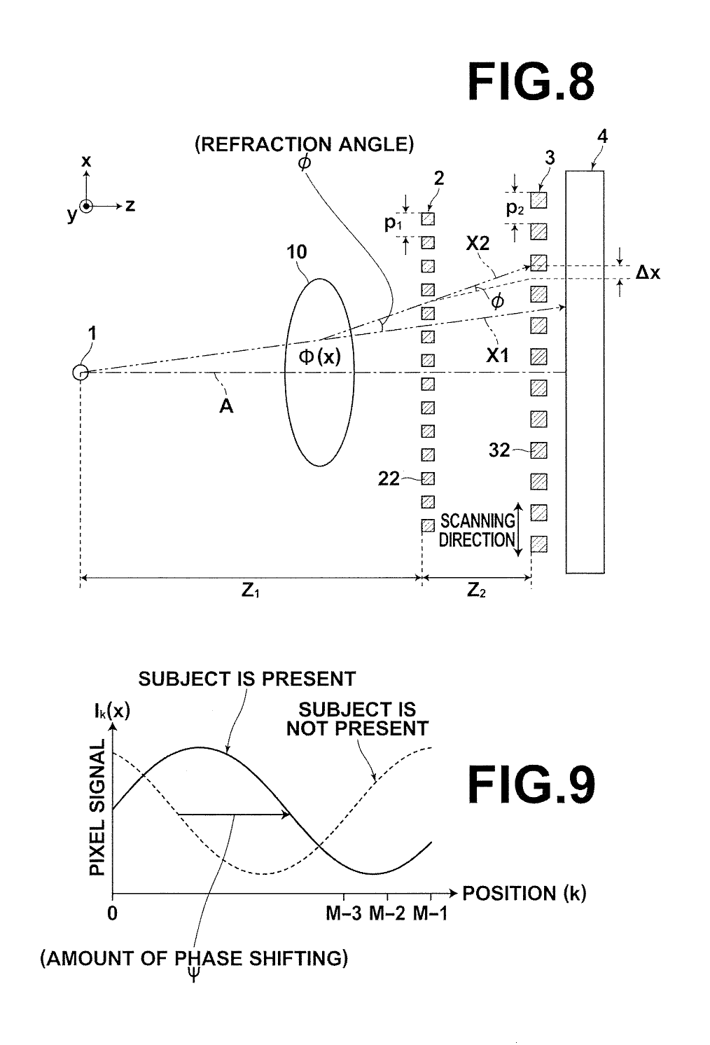

Although FIG. 8 only shows one set of the thirty-six pixel circuits 40 corresponding to one pixel of the phase contrast image, this set is repeatedly arranged along the X-direction and the Y-direction.

Each pixel circuit 40 includes a photoelectric conversion element, a charge storing section to store an electric charge obtained by conversion by the photoelectric conversion element, and the TFT switch 41 to read out an electric charge signal stored in the charge storing section. Although not shown in the drawing, a wavelength conversion layer to convert the applied radiation into visible light is disposed on the pixel circuit 40 shown in FIG. 7, and the photoelectric conversion element applies photoelectric conversion to light emitted from the wavelength conversion layer to generate the electric charge.

The image generation unit 5 generates a pixel signal of each pixel forming the phase contrast image based on the detection signals of the five pieces of phase information with respect to each of the X-direction and the Y-direction detected by the above-described thirty-six pixel circuits 40. A method for generating the phase contrast image will be described in detail later.

Next, the operation of the radiographic phase-contrast imaging apparatus of this embodiment is described.

First, as shown in FIG. 1, the subject 10 is placed between the radiation emission unit 1 and the first grating 2, and then radiation is emitted from the radiation emission unit 1. The radiation is transmitted through the subject 10 and is applied onto the first grating 2. The radiation applied onto the first grating 2 is diffracted by the first grating 2 to form a Talbot interference image at a predetermined distance from the first grating 2 in the direction of the optical axis of the radiation.

This phenomenon is called the Talbot effect where, when the light wave passes through the first grating 2, the self images G1 and G2 of the first grating 2 are formed at a predetermined distance from the first grating 2. For example, in the case where the first grating 2 is a phase modulation grating that applies phase modulation of 90°, the self images G1 and G2 of the first grating 2 are formed at the distance found by Expression (4) or (7) above (Expression (5) or (8) above in the case where the first grating 2 is a phase modulation grating that applies phase modulation of 180°, and Expression (6) or (9) above in the case where the first grating 2 is an intensity modulation grating). On the other hand, the wave front of the radiation entering the first grating 2 is distorted by the subject 10 and the self images G1 and G2 of the first grating 2 are deformed accordingly. That is, the above-described self images G1 and G2 of the first and second unit gratings UG1 and UG2 of the first grating 2 are deformed by the subject 10.

Subsequently, the self images G1 and G2 of the first and second unit gratings UG1 and UG2 pass through the sub-unit gratings SUG1A to SUG5A and SUG1B to SUG5B of the second grating 3. As a result, the deformed self images G1 and G2 of the first and second unit gratings UG1 and UG2 are superposed on the sub-unit gratings of the second grating 3 to be subjected to intensity modulation, and then are detected by the pixel circuits 40 of the radiographic image detector 4 as an image signal which reflects the above-described distortion of the wave front.

Now, an operation of image detection and reading with the image radiographic image detector 4 is described.

The self images G1 and G2 of the first and second unit gratings UG1 and UG2, which are deformed by the intensity modulation by the sub-unit gratings of the second grating 3, as described above, are detected by the pixel circuits 40 of the radiographic image detector 4 corresponding to the sub-unit gratings, and are subjected to the photoelectric conversion by the photoelectric conversion elements of the pixel circuits 40. Then, the thus generated electric charges are stored in the charge storing sections.

Then, the scanning signals are sequentially outputted from the scanning drive circuit 45 to the gate scanning lines 43 arranged along the Y-direction, and the pixel circuit rows are sequentially scanned along the Y-direction to read out the detection signals from the pixel circuits 40. The detection signals are detected by the signal detection unit 46 and outputted to the image generation unit 5.

Then, the image generation unit 5 obtains detection signals of X-direction components based on the detection signals detected by the pixel circuits 40 corresponding to the self image G1 of the first unit grating UG1 and obtains detection signals of Y-direction components based on the detection signals detected by the pixel circuits 40 corresponding to the self image G2 of the second unit grating UG2, and generates a pixel signal of one pixel of the phase contrast image of the subject 10 based on the detection signals of the X-direction components and the Y-direction components.

Now, how the phase contrast image is generated at the image generation unit 5 is described. First, the principle of the method for generating the phase contrast image in this embodiment is described. In this description, the principle of a method for generating a phase contrast image of the X-direction components is explained. The principle of a method for generating a phase contrast image of the Y-direction components is the same as the method for generating the phase contrast image of the X-direction components, except that the direction is different.

FIG. 8 shows an example of one radiation path which is refracted depending on a phase shift distribution Φ(x) of the subject 10 with respect to the X-direction. The symbol X1 denotes a straight radiation path in a case where the subject 10 is not present. The radiation traveling along the path X1 passes through the first grating 2 and the second grating 3 and enters the radiographic image detector 4. The symbol X2 denotes a radiation path which is deflected due to refraction by the subject 10 in a case where the subject 10 is present. The radiation traveling along the path X2 passes through the first grating 2, and then is shielded by the second grating 3.

Assuming that a refractive index distribution of the subject 10 is n(x, z), and a direction in which the radiation travels is z, the phase shift distribution Φ(x) of the subject 10 is expressed by Expression (10) below (where the y-coordinate is omitted for simplifying explanation):

$$Φ ( x ) = \frac{2 π}{λ} \int [ 1 - n ( x , z ) ] d z \qquad ( 10 )$$

The self images G1 and G2 formed by the first grating 2 at the position of the second grating 3 is displaced in the x-direction by an amount depending on the refraction angle φ of the refraction of radiation by the subject 10. The amount of displacement Δx is approximately expressed by Expression (11) below based on the fact that the refraction angle φ of the radiation is very small:

Δx≈Z₂φ (11)

The refraction angle φ is expressed by Expression (12) below by using the wavelength λ of the radiation and the phase shift distribution Φ(x) of the subject 10:

$$ϕ = \frac{λ}{2 π} \frac{\partial Φ ( x )}{\partial x} \qquad ( 12 )$$

In this manner, the amount of displacement Δx of the self images G1 and G2 due to the refraction of radiation by the subject 10 is linked to the phase shift distribution Φ(x) of the subject 10. Then, the amount of displacement Ax is linked to an amount of phase shifting Ψ of an intensity-modulated signal of each pixel detected by the radiographic image detector 4 (an amount of phase shifting of the intensity-modulated signal of each pixel between the cases where the subject 10 is present and where the subject 10 is not present), as expressed by Expression (13) below:

$$ψ = \frac{2 π}{{P}_{2}} \\ Δ x = \frac{2 π}{{P}_{2}} {Z}_{2} ϕ \qquad ( 13 )$$

Therefore, by finding the amount of phase shifting Ψ of the intensity-modulated signal of each pixel, the refraction angle φ is found from Expression (13) above, and a differential of the phase shift distribution Φ(x) is found with using Expression (12) above. By integrating the differential with respect to x, the phase shift distribution Φ(x) of the subject 10, i.e., the phase contrast image of the subject 10 can be generated.

In this embodiment, detection signals of the five types of phase information are obtained for each pixel of the phase contrast image. Now, a method for calculating the amount of phase shifting Ψ of the intensity modulation signal of each pixel of the phase contrast image from the detection signals of the five types of phase information is described. In this description, the number of the detection signals is not limited to five, and a method for calculating the amount of phase shifting Ψ based on M types of detection signals is described.

First, in order to obtain the M types of detection signals, it is necessary to place M types of sub-unit gratings with different distances in the X-direction relative to the self images G1 and G2 of the first unit grating UG1. Assuming that the positions of the M types of sub-unit gratings relative to the self images G1 and G2 of the first unit grating UG1 are positions k where k=0 to M-1, a detection signal Ik(x) of each pixel circuit 40 of the radiographic image detector 4 at the k-th position is expressed by Expression (14) below:

$${I}_{k} ( x ) = {A}_{0} + {\sum }_{n > 0} {A}_{n} exp [ 2 πi \frac{n}{{P}_{2}} \{ {Z}_{2} ϕ ( x ) + \frac{{kP}_{2}}{M} \} ] \qquad ( 14 )$$

where x is a coordinate of the pixel circuit with respect to the x-direction, A₀ is an intensity of the incident radiation, and Aₙ is a value corresponding to the contrast of the intensity-modulated signal (where n is a positive integer). Further, φ(x) represents the refraction angle φ as a function of the coordinate x of each pixel circuit of the radiographic image detector 4.

Then, using the relational expression of Expression (15) below, the refraction angle φ(x) is expressed as Expression (16) below:

$$\begin{matrix}{\sum }_{k = 0}^{M - 1} exp ( - 2 π i \frac{k}{M} ) = 0 & ( 15 ) \\ ϕ ( x ) = \frac{{p}_{2}}{2 π {Z}_{2}} arg [ {\sum }_{k = 0}^{M - 1} {I}_{k} ( x ) exp ( - 2 π i \frac{k}{M} ) ] & ( 16 )\end{matrix}$$

where “arg[]” means extraction of an argument, and corresponds to the amount of phase shifting Ψ of each pixel of the radiographic image detector 4. Therefore, the refraction angle φ(x) is found by calculating, based on Expression (16), the amount of phase shifting Ψ of the intensity-modulated signal of each pixel of the phase contrast image from the M types of detection signals obtained by the radiographic image detector 4.

As shown in FIG. 9, the M types of detection signals obtained for each pixel of the phase contrast image periodically vary with respect to the position k of each of the M types of sub-unit gratings relative to the self images G1 and G2. Therefore, the phase shift distribution Φ(x) of the subject 10, i.e., the phase contrast image of the X-direction components of the subject 10, is generated by fitting a string of the M detection signals with a sinusoidal wave, for example, obtaining the amount of phase shifting Ψ of the fitting curve in each of the cases where the subject is present and the subject is not present, calculating the differential of the phase shift distribution Φ(x) according to the Expressions (12) and (13) above, and integrating the differential with respect to x.

More specifically, the above-described Expression (16) expressing the refraction angle φ(x) can be expressed as Expression (17) below:

$$ϕ ( x ) ∝ A \cdot arg [ \frac{{\sum }_{k = 0}^{M - 1} {I}_{k} sin {δ}_{k}}{{\sum }_{k = 0}^{M - 1} {I}_{k} cos {δ}_{k}} ] \qquad ( 17 )$$

In the above Expression, δk can be expressed by Expression (18) below. Therefore, assuming that M=5, as in this embodiment, a detection signal corresponding to the two sub-unit gratings SUG1B shown in FIG. 6 at the position k=0 is I₀, a detection signal corresponding to the two sub-unit gratings SUG2B at the position k=1 is I₁, a detection signal corresponding to the two sub-unit gratings SUG3B at the position k=2 is I₂, a detection signal corresponding to the two sub-unit gratings SUG4B at the position k=3 is I₃ and a detection signal corresponding to the sub-unit grating SUG5B at the position k=4 is I₄, the terms in the parenthesis of Expression (17) above can be calculated as shown by Expression (19) below, and thus the refraction angle φ(x) can be calculated. It should be noted that, since two detection signals are obtained for each of the detection signals I₀ to I₃, the two detection signals are assigned to the numerator and denominator, respectively, in Expression (19) below. With respect to one detection signal obtained for the detection signal I₄, the same value of the one detection signal is assigned to both the numerator and denominator in the Expression (19) below.

$$\begin{matrix} {δ}_{k} = \frac{2 π k}{M} \\ & ( 18 ) \\ ϕ ( x ) ∝ A \cdot arg [ \frac{\begin{matrix}{I}_{0} sin \frac{π \cdot 0}{5} + {I}_{1} sin \frac{π \cdot 1}{5} + {I}_{2} sin \frac{π \cdot 2}{5} + \\ {I}_{3} sin \frac{π \cdot 3}{5} + {I}_{4} sin \frac{π \cdot 4}{5}\end{matrix}}{\begin{matrix}{I}_{0} cos \frac{π \cdot 0}{5} + {I}_{1} cos \frac{π \cdot 1}{5} + {I}_{2} cos \frac{π \cdot 2}{5} + \\ {I}_{3} cos \frac{π \cdot 3}{5} + {I}_{4} cos \frac{π \cdot 4}{5}\end{matrix}} ] ∝ A \cdot arg [ \frac{\begin{matrix}{I}_{0} \cdot 0 + {I}_{1} \cdot 0.95 + {I}_{2} \cdot 0.59 + \\ {I}_{3} \cdot ( - 0.59 ) + {I}_{4} \cdot ( - 0.95 )\end{matrix}}{\begin{matrix}{I}_{0} \cdot 1 + {I}_{1} \cdot 0.79 + {I}_{2} \cdot 0.24 + \\ {I}_{3} \cdot ( - 0.41 ) + {I}_{4} \cdot ( - 0.88 )\end{matrix}} ] & ( 19 )\end{matrix}$$

It should be noted that, when the phase contrast image is generated as described above, information as to whether the detection signal detected by each pixel circuit 40 corresponds to the sub-unit grating, i.e., information about the position k of the sub-unit grating corresponding to the detection signal relative to the self image G1, G2 is necessary. This correspondence relationship may be set in advance for each pixel circuit 40.

Alternatively, rather than setting the correspondence relationship in advance, a range of nine pixel circuits 40 corresponding to the nine sub-unit gratings may be set in advance, and a maximum value and a minimum value of detection signals detected by the pixel circuits 40 in this range may be found. Then, the maximum value and the minimum value may be set as a maximum value and a minimum value of the above-described fitting curve and the values of the other pixel signals may be set as values between the maximum value and the minimum value of the fitting curve, thereby generating the phase contrast image.

In this manner, a first X-direction component detection signal is obtained based on the detection signals of the nine pixel circuits 40 in the range corresponding to one of the two first unit gratings UG1 shown in FIG. 4 (the range corresponding to the nine sub-unit gratings SUG1B to SUG5B).

Also, a second X-direction component detection signal is obtained based on the detection signals of the nine pixel circuits 40 in the range corresponding to the other of the two first unit gratings UG1 shown in FIG. 4 (the range corresponding to the nine sub-unit gratings SUG1B to SUG5B) by the same calculation as that described above.

Then, the image generation unit 5 calculates an X-direction component pixel signal of one pixel of the phase contrast image based on the first X-direction component detection signal and the second X-direction component detection signal. Calculation of the X-direction component pixel signal may be achieved, for example, by averaging the first and second X-direction component detection signals.

In the above description, the method for calculating the X-direction component pixel signal of each pixel of the phase contrast image is explained. The Y-direction component pixel signal can be calculated by the same method with changing only the direction.

Specifically, the refraction angle φ(y) can be calculated by calculating Expression (19) above with assuming that a detection signal corresponding to the two sub-unit gratings SUG1A shown in FIG. 6 at the position k=0 is I₀, a detection signal corresponding to the two sub-unit gratings SUG2A at the position k=1 is I₁, a detection signal corresponding to the two sub-unit gratings SUG3A at the position k=2 is I₂, a detection signal corresponding to the two sub-unit gratings SUG4A at the position k=3 is I₃ and a detection signal corresponding to the sub-unit grating SUG5A at the position k=4 is I₄.

Then, similarly to the case of the X-direction components, the image generation unit 5 obtains a first Y-direction component detection signal and a second Y-direction component detection signal based on the detection signals of the pixel circuits 40 in the ranges corresponding to the two second unit gratings UG2 shown in FIG. 4.

Then, a Y-direction component pixel signal of one pixel of the phase contrast image is calculated based on the first Y-direction component detection signal and the second Y-direction component detection signal. Calculation of the Y-direction component pixel signal may be achieved, for example, by averaging the first and second Y-direction component detection signals.

Further, the image generation unit 5 generates the pixel signal of one pixel of the phase contrast image based on the X-direction component pixel signal and the Y-direction component pixel signal, which are obtained as described above. Specifically, for example, the image generation unit 5 may average the X-direction component pixel signal and the Y-direction component pixel signal to generate the pixel signal.

Although the unit grating members of the first unit grating UG1 and the second unit grating UG2 are arranged orthogonal to each other in the above-described embodiment, they may not necessarily be orthogonal. For example, the unit grating members of the first unit grating UG1 and the second unit grating UG2 may be arranged such that an angle other than 90 degrees is formed therebetween. Also in this case, the positional relationship between the image of the unit grating members of each unit grating and the sub-unit grating members of each sub-unit grating of the second grating 3 is maintained.

Although the first grating 2 is formed by the two types of unit gratings in the above-described embodiment, this is not intended to limit the invention. For example, the first grating 2 may be formed by three types of unit gratings wherein sets of the unit grating members of the individual unit gratings are arranged at angles different from each other by an angle of 60 degrees, such as a unit grating with the unit grating members arranged at an angle of 0 degree relative to the X-direction or Y-direction, a unit grating with the unit grating members arranged at an angle of 60 degrees relative to the X-direction or Y-direction, and a unit grating with the unit grating members arranged at an angle of 120 degrees relative to the X-direction or Y-direction. In this case, for each unit grating, a detection signal of a direction component in a direction orthogonal to the angle of the unit grating members of the unit grating is calculated, so that each pixel signal is generated based on the detection signals of three direction components. Further alternatively, the first grating 2 may be formed by four types of unit gratings wherein sets of the unit grating members of the individual unit gratings are arranged at angles different from each other by an angle of 45 degrees, so that each pixel signal is generated based on detection signals of four direction components.

Further, although it is desirable that a ratio of an area occupied by the two first unit gratings UG1 to an area occupied by the two second unit gratings UG2 within the range corresponding to each pixel of the phase contrast image is 1:1, as shown in FIG. 4, this ratio may not necessarily be 1:1. Further alternatively, sets of the first and second unit gratings UG1 and UG2 with different area ratios between the first unit grating UG1 and the second unit grating UG2 may be provided within the range corresponding to each pixel of the phase contrast image. For example, a set of the first and second unit gratings with an area ratio of 1:2 and a set of the first and second unit gratings with an area ratio of 2:1 may be provided within the range corresponding to each pixel of the phase contrast image.

Further, for example, the arrangement pitch of the unit grating members 22 of one of the two first unit gratings UG1 shown in FIG. 4 and the arrangement pitch of the unit grating members 22 of the other of the two first unit gratings UG1 may be different from each other. In this case, X-direction component detection signals having different types of frequency information can be obtained, and an energy subtraction phase contrast image can be generated by calculating a difference between these X-direction component detection signals to generate the X-direction component pixel signal of each pixel signal. While the two first unit gratings UG1 have different arrangement pitches in the above description, the two second unit gratings UG2 may also have different arrangement pitches.

In the above-described embodiment, the five sub-unit gratings to provide different types of phase information, which have the sub-unit grating members 32 arranged at the arrangement pitch P₂, are disposed in the range corresponding to each unit grating of the first grating 2, so that a pixel signal of each direction component is generated based on the detection signals detected by the pixel circuits 40 corresponding to the five sub-unit gratings. However, in addition to the set of five sub-unit gratings to provide different types of phase information with the sub-unit grating members 32 arranged at the arrangement pitch P₂, a set of five sub-unit gratings to provide different types of phase information with the sub-unit grating members 32 arranged at an arrangement pitch P₂′, which is different from the arrangement pitch P₂, may be disposed in the range corresponding to each unit grating, so that pixel signals of the same direction components with a different type of frequency information are calculated based on signals detected by the pixel circuits 40 corresponding to the sub-unit gratings with the arrangement pitch P₂′. It should be noted that the “five sub-unit gratings to provide different types of phase information with the sub-unit grating members arranged at the arrangement pitch P₂′” refer to sub-unit gratings that are arranged with different distances at a pitch of P₂′/5 relative to the image of the unit gratings of the first grating 2.

That is, a direction component pixel signal having the first frequency information may be calculated based on the detection signals detected by the pixel circuits 40 corresponding to the five sub-unit gratings to provide different types of phase information with the arrangement pitch P₂, and a direction component pixel signal having the second frequency information may be calculated based on the detection signals detected by the pixel circuits 40 corresponding to the five sub-unit gratings to provide different types of phase information with the arrangement pitch P₂′. Then, a difference between these direction component pixel signals may be calculated to generate a pixel signal of one direction component.

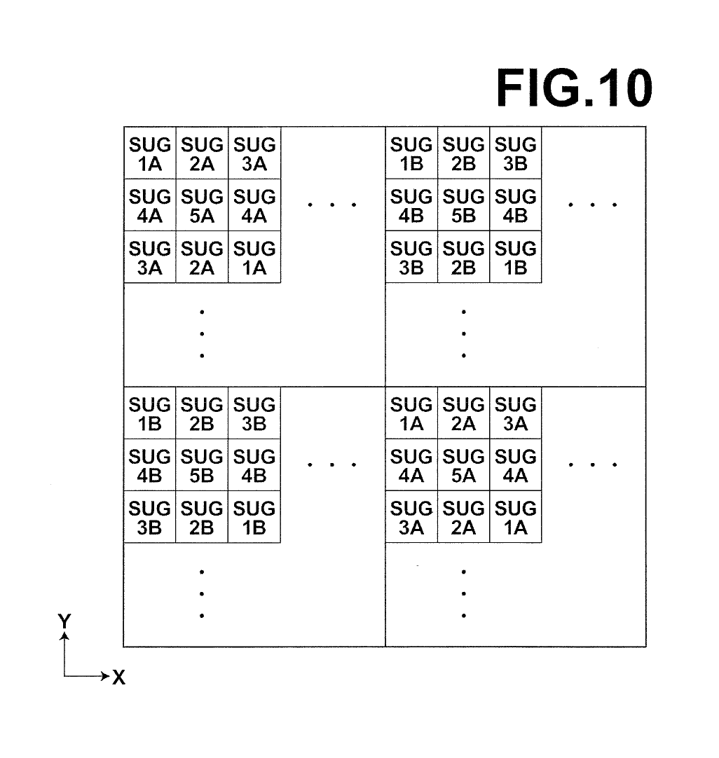

In the above-described embodiment, the nine sub-unit gratings to provide five types of phase information to generate the detection signal of one direction component are arranged in the range corresponding to each unit grating of the first grating 2. However, the size of one unit grating and the size of nine sub-unit gratings may not necessarily be the same. For example, as shown in FIG. 10, a plurality of sets of nine sub-unit gratings may be arranged within the range corresponding to each unit grating.

That is, the size of the self image G1, G2 of each unit grating of the first grating 2 may be equal to or larger than the size of each set of the sub-unit gratings to provide five types of phase information to generate one direction component detection signal. Since each sub-unit grating corresponds to each pixel circuit 40, as described above, the size of each set of the sub-unit gratings to provide five types of phase information is larger than the size of each pixel circuit.

Further, bridges may partially be disposed in the second grating 3. The bridge is a member disposed between the grating members forming the second grating 3 to join the grating members with each other, and is formed by the same material as the material forming the grating member. The bridges maybe arranged at the same interval as the interval of the sub-unit grating units.

Still further, the configuration of the first grating 2 and the configuration of the second grating 3 in the above-described embodiment may be reversed. That is, the first grating 2 may be formed by the sub-unit gratings and the second grating 3 may be formed by the unit gratings.

Next, a radiographic phase-contrast imaging apparatus employing a second embodiment of the radiographic imaging apparatus of the invention is described. In the above-described radiographic phase-contrast imaging apparatus of the first embodiment, the distance Z₂ from the first grating 2 to the second grating 3 is determined to satisfy corresponding one of Expressions (4) to Expression (9) above so that it becomes the Talbot interference distance. In the radiographic phase-contrast imaging apparatus of the second embodiment, the first grating 2 is adapted to project the incident radiation without diffracting the radiation. In this case, similar projection images passed through the first grating 2 can be obtained at any position behind the first grating 2, and therefore the distance Z₂ from the first grating 2 to the second grating 3 can be set irrespectively of the Talbot interference distance.

Specifically, in the radiographic phase-contrast imaging apparatus of the second embodiment, both the first grating 2 and the second grating 3 are formed as absorption type (amplitude modulation type) gratings and are adapted to geometrically project the radiation passed through the slits irrespectively of the Talbot interference effect. In more detail, by setting values of the interval d₁ of the unit grating members 22 of the first grating 2 and the interval d₂ of the sub-unit grating members 32 of the second grating 3 sufficiently greater than the effective wavelength of the radiation applied from the radiation emission unit 1, the most part of the applied radiation can travel straight and pass through the slits without being diffracted by the slits. For example, in the case of the radiation source with a tungsten target, the effective wavelength of the radiation is about 0.4 Å at a tube voltage of 50 kV. In this case, the most part of the radiation is geometrically projected without being diffracted by the slits by setting the interval d₁ of the unit grating members 22 of the first grating 2 and the interval d₂ of the sub-unit grating members 32 of the second grating 3 on the order of 1 μm to 10 μm.

It should be noted that the relationship between the arrangement pitch P₁ of the unit grating members 22 of the first grating 2 and the arrangement pitch P₂ of the sub-unit grating members 32 of the second grating 3 is the same as that in the first embodiment. Also, the configuration of the sub-unit gratings of the second grating 3 relative to each unit grating of the first grating 2 is the same as that in the first embodiment.

In the second embodiment, the distance Z₂ between the first grating 2 and the second grating 3 can be set at a value that is shorter than the minimum Talbot interference distance when m′=1 in Expression (6) above. That is, the value of the distance Z₂ can be set within a range where Expression (20) below is satisfied:

$${Z}_{2} < \frac{{P}_{1} {P}_{2}}{λ} \qquad ( 20 )$$

In order to generate a high-contrast periodic pattern image, it is preferred that the unit grating members 22 of the first grating 2 and the sub-unit grating members 32 of the second grating 3 completely shield (absorb) the radiation. However, even when the above-described material (such as gold or platinum) having high radiation absorption is used, no small part of the radiation is transmitted without being absorbed. Therefore, in order to increase the radiation shielding property, the thicknesses of the unit grating members 22 and sub-unit grating members 32 may be made as thick as possible. The unit grating members 22 and sub-unit grating members 32 may shield 90% or more of the radiation applied thereto . For example, if the tube voltage of the radiation emission unit 1 is 50 kV, the thicknesses may be 100 μm or more when the unit grating members 22 and sub-unit grating members 32 are made of gold (Au).

To generate the phase contrast image with the radiographic phase-contrast imaging apparatus of the second embodiment, the same method as that in the first embodiment is used.

According to the radiographic phase-contrast imaging apparatus of the second embodiment, the distance Z₂ between the first grating 2 and the second grating 3 can be made shorter than the Talbot interference distance. In this case, the imaging apparatus can be made thinner than the radiographic phase-contrast imaging apparatus of the first embodiment, which has to ensure a certain Talbot interference distance.

Similarly to the first embodiment, any of the various configurations of the unit gratings of the first grating 2 and the sub-unit gratings of the second grating 3 may be employed in the second embodiment.

As yet another variation, one of the first unit gratings UG1 and the second unit gratings UG2 shown in FIG. 4 may be formed as absorption type gratings, as described above, so that they geometrically project the radiation passed through the slits regardless of the Talbot interference effect, and the other of the first unit gratings UG1 and the second unit gratings UG2 may be formed to provide the Talbot interference effect as in the first embodiment. Alternatively, one of the two first unit gratings UG1 may be formed as an absorption type grating, as described above, so that it geometrically projects the radiation passed through the slits regardless of the Talbot interference effect, and the other of the two first unit gratings UG1 may be formed to provide the Talbot interference effect as in the first embodiment. Still alternatively, one of the two second unit gratings UG2 may be formed as an absorption type grating, as described above, so that it geometrically projects the radiation passed through the slits regardless of the Talbot interference effect, and the other of the two second unit gratings UG2 may be formed to provide the Talbot interference effect as in the first embodiment.

These configurations allow obtaining information of a certain wavelength in the case where the Talbot interference is provided, or allow obtaining information of a wide wavelength range at once in the case of projection. By combining these configurations, efficient use of X-ray energy and increase of image information can be achieved.

Although the radiographic image detector of the TFT reading system is used in the above-described first and second embodiments, a radiographic image detector using a CMOS sensor or a radiographic image detector of an optical reading system may be used. Further, in place of the wavelength conversion layer to convert the radiation into visible light, a direct conversion layer that directly converts the radiation into electric charges may be used. Now, a radiographic image detector of an optical reading system is described.

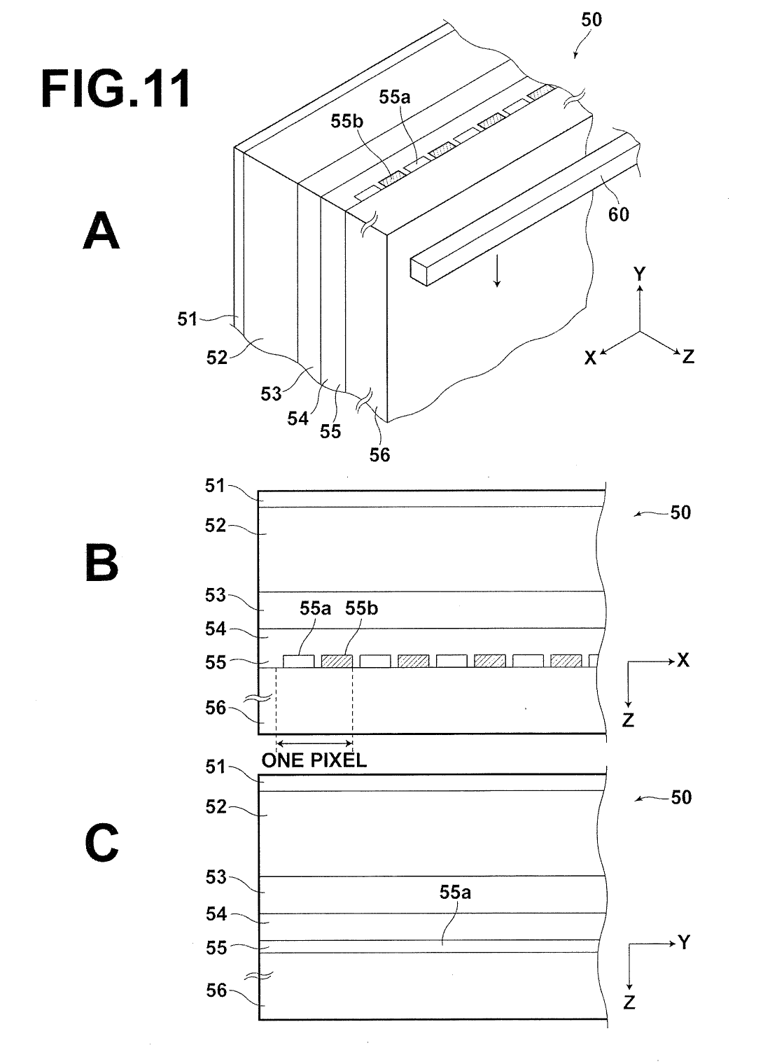

In FIG. 11, a perspective view of a radiographic image detector 50 of an optical reading system is shown at “A”, a sectional view of the radiographic image detector shown at A taken along the XZ-plane is shown at “B”, and a sectional view of the radiographic image detector shown at A taken along the YZ-plane is shown at “C”.

As shown at A to C in FIG. 11, the radiographic image detector 50 of the optical reading system includes: a first electrode layer 51 that transmits radiation; a recording photoconductive layer 52 that generates electric charges when exposed to the radiation transmitted through the first electrode layer 51; an electric charge storing layer 53 that acts as an insulator against the electric charges of one of the polarities generated at the recording photoconductive layer 52 and acts as an conductor for the electric charges of the other of the polarities generated at the recording photoconductive layer 52; a reading photoconductive layer 54 that generates electric charges when exposed to reading light; and a second electrode layer 55, which are formed on a glass substrate 56 in this order with the second electrode layer 55 being formed on the glass substrate 56.

The first electrode layer 51 is made of a material that transmits radiation. Examples of the usable material may include NESA film (SnO₂), ITO (Indium Tin Oxide), IZO (Indium Zinc Oxide), and IDIXO (Idemitsu Indium X-metal Oxide, available from Idemitsu Kosan Co., Ltd.) which is an amorphous light-transmitting oxide film. The thickness of the first electrode layer 51 is in the range from 50 to 200 nm. As other examples, Al or Au with a thickness of 100 nm may be used.

The recording photoconductive layer 52 is made of a material that generates electric charges when exposed to radiation. In view of relatively high quantum efficiency with respect to radiation and high dark resistance, a material mainly composed of a-Se is used. An appropriate thickness of the recording photoconductive layer 52 is in the range from 10 μm to 1500 μm. For mammography, in particular, the thickness of the recording photoconductive layer 52 may be in the range from 150 μm to 250 μm. For general imaging, the thickness of the recording photoconductive layer 52 may be in the range from 500 μm to 1200 μm.

The electric charge storing layer 53 is a film that insulates the electric charges of a polarity intended to be stored. Examples of the material forming the electric charge storing layer 53 may include:polymers, such as an acrylic organic resin, polyimide, BCB, PVA, acryl, polyethylene, polycarbonate and polyetherimide; sulfides, such as As₂S₂, Sb₂S₂ and ZnS; oxides; and fluorides. Optionally, the material forming the electric charge storing layer 53 insulates the electric charges of a polarity intended to be stored and conducts the electric charges of the opposite polarity. Further optionally, such a material that a product of mobility×life varies by as much as three digits or more depending on the polarity of the electric charges may be used.

Examples of compounds may include: As₂Se₃; As₂Se₃ doped with 500 ppm to 20000 ppm of Cl, Br or I; As₂(SeₓTe₁₋ₓ)₃ (where 0.5<x<1) provided by substituting about 50% of Se of As₂Se₃ with Te; a compound provided by substituting about 50% of Se of As₂Se₃ with S; AsₓSe_{y} (where x+y=100, 34≦x≦46) provided by changing the As concentration of As₂Se₃ by about ±15%; and an amorphous Se—Te where the Te content is 5 to 30 wt %.

The material forming the electric charge storing layer 53 may have a permittivity in the range from a half to twice of the permittivity of the recording photoconductive layer 52 and the reading photoconductive layer 54 so that a straight line of electric force formed between the first electrode layer 51 and the second electrode layer 55 is maintained.

The reading photoconductive layer 54 is made of a material that becomes conductive when exposed to the reading light. Examples of the material forming the reading photoconductive layer 54 may include photoconductive materials mainly composed of at least one of a-Se, Se—Te, Se—As—Te, metal-free phthalocyanine, metal phthalocyanine, MgPc (Magnesium phthalocyanine), VoPc (phase II of Vanadyl phthalocyanine), CuPc (Copper phthalocyanine), etc. The thickness of the reading photoconductive layer 54 may be in the range from about 5 to about 20 μm.

The second electrode layer 55 includes a plurality of transparent linear electrodes 55a that transmit the reading light and a plurality of light-shielding linear electrodes 55b that shield the reading light. The transparent linear electrodes 55a and light-shielding linear electrodes 55b continuously extend from one end to the other end of an imaging area of the radiographic image detector 50 in straight lines. As shown at A and B in FIG. 11, the transparent linear electrodes 55a and the light-shielding linear electrodes 55b are alternately arranged at a predetermined interval in parallel with each other.

The transparent linear electrodes 55a are made of a material that transmits the reading light and is electrically conductive. For example, similarly to the first electrode layer 51, the transparent linear electrodes 55a maybe made of ITO, IZO or IDIXO. The thickness of the transparent linear electrodes 55a is in the range from about 100 to about 200 nm.

The light-shielding linear electrodes 55b

are made of a material that shields the reading light and is electrically conductive. For example, the light-shielding linear electrodes 55b may be formed by a combination of the above-described transparent electrically conducting material and a color filter. The thickness of the transparent electrically conducting material is in the range from about 100 to about 200 nm.

In the above-described radiographic image detector 50 of the optical reading system, one set of the transparent linear electrode 55a and the light-shielding linear electrode 55b adjacent to each other is used to read out an image signal, as described in detail later. Namely, as shown at B in FIG. 11, one set of the transparent linear electrode 55a and the light-shielding linear electrode 55b reads out an image signal of one pixel. That is, one set of the transparent linear electrode 55a and the light-shielding linear electrode 55b is equivalent to a column of the pixel circuits 40 of the radiographic image detector 4 in the first embodiment. In this example, the transparent linear electrodes 55a and the light-shielding linear electrodes 55b are arranged such that one pixel is substantially 50 μm.

As shown at A in FIG. 11, the radiographic phase-contrast imaging apparatus of this embodiment also includes a linear reading light source 60, which extends in a direction (the X-direction) orthogonal to the direction along which the transparent linear electrodes 55a and the light-shielding linear electrodes 55b extend. The linear reading light source 60 of this embodiment is formed by a light source, such as LED (Light Emitting Diode) or LD (Laser Diode), and a predetermined optical system, and is adapted to apply linear reading light having a width of substantially 10 μm to the radiographic image detector 50 in a direction (the Y-direction) in which the transparent linear electrodes 55a and the light-shielding linear electrodes 55b extend. The linear reading light source 60 is moved by a predetermined moving mechanism (not shown) relative to the Y-direction. As the linear reading light source 60 is moved in this manner, the linear reading light emitted from the linear reading light source 60 scans the radiographic image detector 50 to read out the image signals.

Therefore, a reading line of the linear reading light is equivalent to a row of the pixel circuits 40 of the radiographic image detector 4 in the first embodiment. Since one set of the transparent linear electrode 55a and the light-shielding linear electrode 55b is equivalent to a column of the pixel circuits 40 of the radiographic image detector 4 in the first embodiment, as described above, the reading line and the one set of the transparent linear electrode 55a and the light-shielding linear electrode 55b form a pixel section in the radiographic image detector 50 of the optical reading system, and the unit gratings of the first grating 2 are formed according to this unit of pixel section.

Next, an operation of image detection and reading with the radiographic image detector 50 of the optical reading system is described.

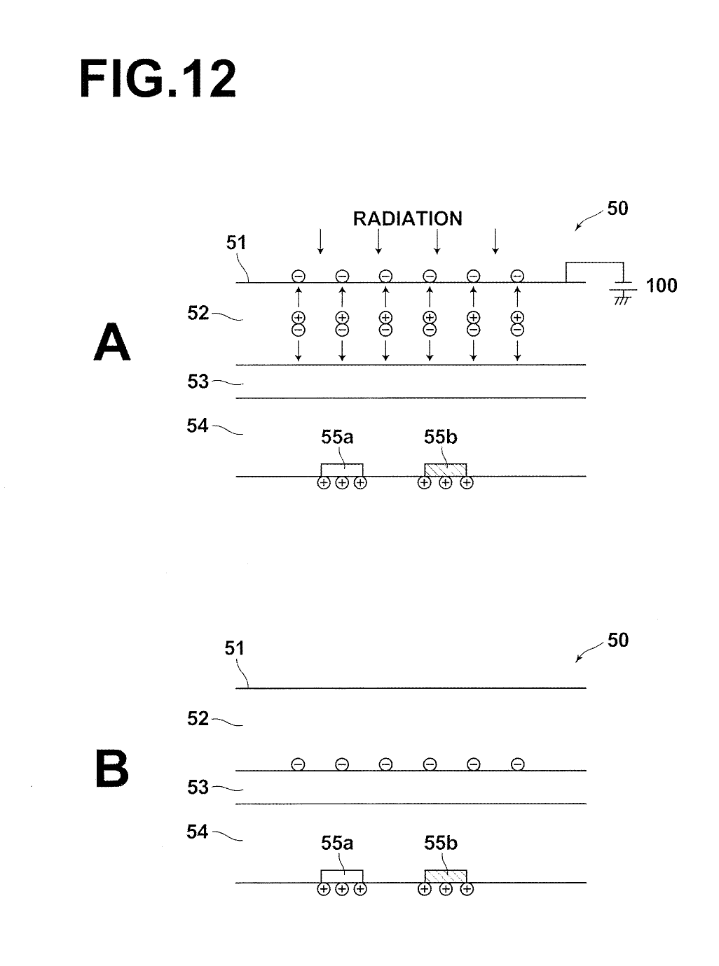

First, as shown at “A” in FIG. 12, in a state where a high-voltage power supply 100 applies a negative voltage to the first electrode layer 51 of the radiographic image detector 50, the radiation with the intensity thereof modulated by superposing the self images G1 and G2 of the first grating 2 on the second grating 3 is applied to the radiographic image detector 50 from the first electrode layer 51 side thereof.

Then, the radiation applied to the radiographic image detector 50 is transmitted through the first electrode layer 51 to be applied to the recording photoconductive layer 52. The application of the radiation causes generation of electron-hole pairs at the recording photoconductive layer 52. Among the generated electric charge pairs, positive electric charges are combined with negative electric charges charged in the first electrode layer 51 and disappear, and negative electric charges are stored as latent image electric charges in the electric charge storing layer 53 (see “B” in FIG. 12).

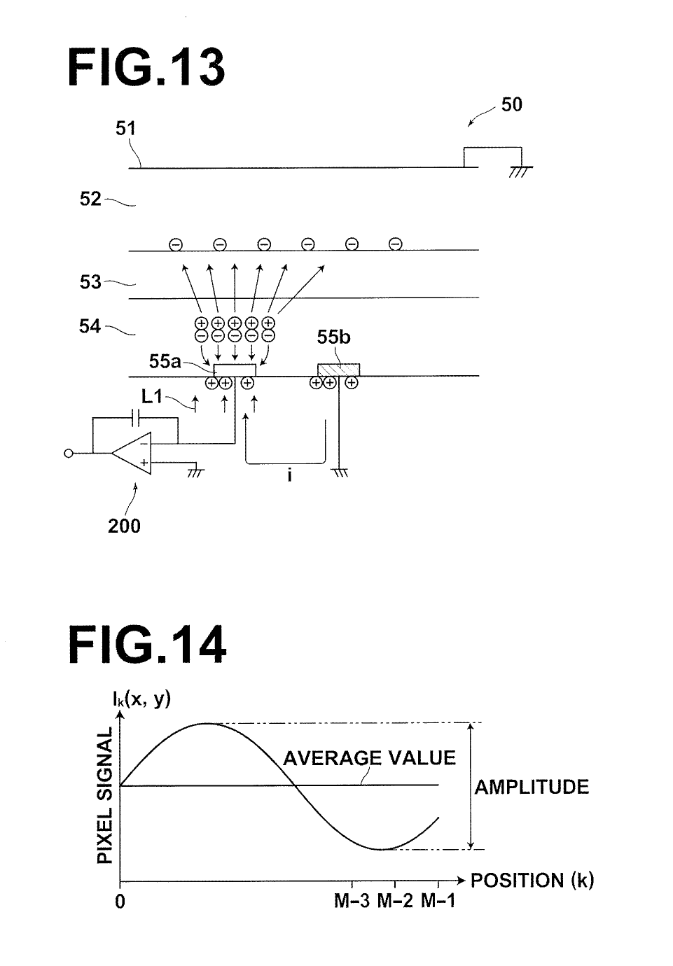

Then, as shown in FIG. 13, in a state where the first electrode layer 51 is grounded, linear reading light L1 emitted from the linear reading light source 60 is applied to the radiographic image detector 50 from the second electrode layer 55 side thereof. The reading light L1 is transmitted through the transparent linear electrodes 55a to be applied to the reading photoconductive layer 54. Positive electric charges generated at the reading photoconductive layer 54 by the application of the reading light L1 are combined with the latent image electric charges stored in the electric charge storing layer 53. Negative electric charges generated at the reading photoconductive layer 54 by the application of the reading light L1 are combined with positive electric charges charged in the light-shielding linear electrodes 55b via a charge amplifier 200 connected to the transparent linear electrodes 55a.

When the negative electric charges generated at the reading photoconductive layer 54 are combined with the positive electric charges charged in the light-shielding linear electrodes 55b, electric currents flow to the charge amplifier 200, and the electric currents are integrated and detected as an image signal.

As the linear reading light source 60 is moved in the Y-direction, the linear reading light L1 scans the radiographic image detector 50. Then, for each reading line exposed to the linear reading light L1, the image signals read out by the above-described operation are sequentially detected, and the detected image signals of each reading line are sequentially inputted to and stored in the image generation unit 5.

Then, similarly to the first embodiment, the image generation unit 5 calculates the X-direction component pixel signal and the Y-direction component pixel signal based on the detection signals corresponding to the five types of sub-unit gratings and generates the pixel signal of one pixel of the phase contrast image based on the X-direction component pixel signal and the Y-direction component pixel signal.

The above-described embodiment provides an image which has conventionally been difficult to be depicted by obtaining a phase contrast image. Since conventional X-ray radiodiagnostics are based on absorption images, referencing an absorption image together with a corresponding phase contrast image can help image interpretation. For example, it is effective that a part of a body site which cannot be depicted in the absorption image is supplemented with image information of the phase contrast image by superposing the absorption image and the phase contrast image one on the other through suitable processing, such as weighting, tone processing or frequency processing.

However, if the absorption image is taken separately from the phase contrast image, it is difficult to successfully superpose the absorption image and the phase contrast image one on the other due to positional change of the subject body part between an imaging operation to take the phase contrast image and an imaging operation to take the absorption image, and the number of imaging operations increases, which increases the burden on the subject. Further, in recent years, small-angle scattering images are drawing attention, besides the phase contrast images and the absorption images. The small-angle scattering image can depict tissue characteristics attributed to a minute structure in a subject tissue, and is expected to be a depiction method for new imaging diagnosis in the fields of cancers and cardiovascular diseases, for example.

To this end, the image generation unit 5 may generate an absorption image or a small-angle scattering image based on the detection signals correspond to the different types of sub-unit gratings, which are obtained to generate the phase contrast image.

Specifically, the absorption image can be generated by averaging pixel signals Ik (x, y), which are obtained for each pixel circuit 40 or each pixel section, with respect to k, as shown in FIG. 14, to calculate an average value for each pixel to form an image. The calculation of the average value may be achieved by simply averaging the pixel signals Ik (x, y) with respect to k. However, since a large error occurs when M is small, the pixel signals Ik (x, y) may be fitted by a sinusoidal wave, and then an average value of the fitted sinusoidal wave may be calculated. Besides a sinusoidal wave, a square wave form or a triangular wave form may be used.

The method used to generate the absorption image is not limited to one using the average value, and any other value corresponding to the average value, such as an addition value calculated by adding up the pixel signals Ik (x, y) with respect to k, may be used.

The small-angle scattering image can be generated by calculating an amplitude value of the pixel signals Ik (x, y) obtained for each pixel circuit 40 or each pixel section to form an image. The calculation of the amplitude value may be achieved by calculating a difference between the maximum value and the minimum value of the pixel signals Ik (x, y). However, since a large error occurs when M is small, the pixel signals Ik (x, y) may be fitted by a sinusoidal wave, and then an amplitude value of the fitted sinusoidal wave may be calculated. The method used to generate the small-angle scattering image is not limited to one using the amplitude value, and any other value corresponding to a variation relative to the average, such as a variance value or a standard deviation, may be used.

Although the two gratings including the first grating 2 and the second grating 3 are used in the radiographic phase-contrast imaging apparatus of the above-described embodiment, the second grating 3 may be omitted by providing the radiographic image detector with the function of the second grating 3. Now, the configuration of a radiographic image detector with the function of the second grating 3 is described.

The radiographic image detector with the function of the second grating 3 detects the self images G1 and G2 of the first grating 2 formed by the first grating 2 when the radiation passes through the first grating 2, and stores electric charge signals according to the self images G1 and G2 in an electric charge storing layer which is divided in a grating pattern, as described later, thereby applying the intensity modulation to the self images G1 and G2.

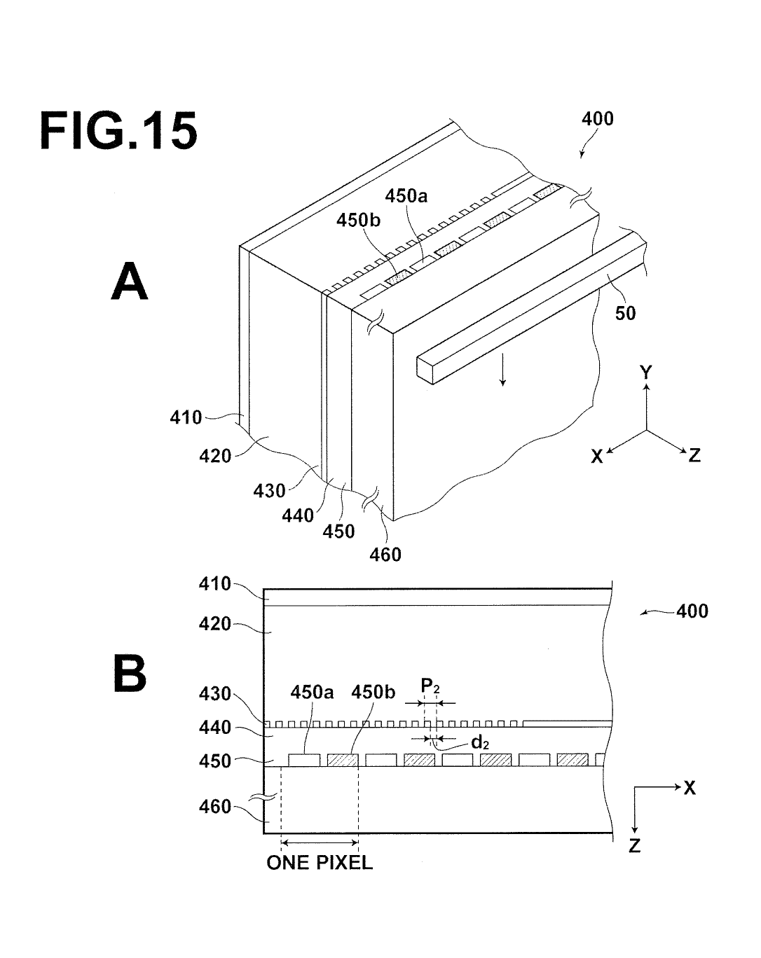

FIG. 15 shows at “A” a perspective view of the radiographic image detector 400 with the function of the second grating 3, and shows at “B” a sectional view of the radiographic image detector taken along the XZ-plane.

As shown at A and B in FIG. 15, the radiographic image detector 400 includes: a first electrode layer 410 that transmits radiation; a recording photoconductive layer 420 that generates electric charges when exposed to the radiation transmitted through the first electrode layer 410; an electric charge storing layer 430 that acts as an insulator against the electric charges of one of the polarities generated at the recording photoconductive layer 420 and acts as an conductor for the electric charges of the other of the polarities generated at the recording photoconductive layer 420; a reading photoconductive layer 440 that generates electric charges when exposed to reading light; and a second electrode layer 450, which are formed on a glass substrate 460 in this order with the second electrode layer 450 being formed on the glass substrate 46.

Materials forming the first electrode layer 410, the recording photoconductive layer 420, the electric charge storing layer 430, the reading photoconductive layer 440 and the second electrode layer 450 of the radiographic image detector 400 with the function of the second grating 3 are the same as those forming the first electrode layer 51, the recording photoconductive layer 52, the electric charge storing layer 53, the reading photoconductive layer 54 and the second electrode layer 55 of the above-described radiographic image detector 50 of the optical reading system.

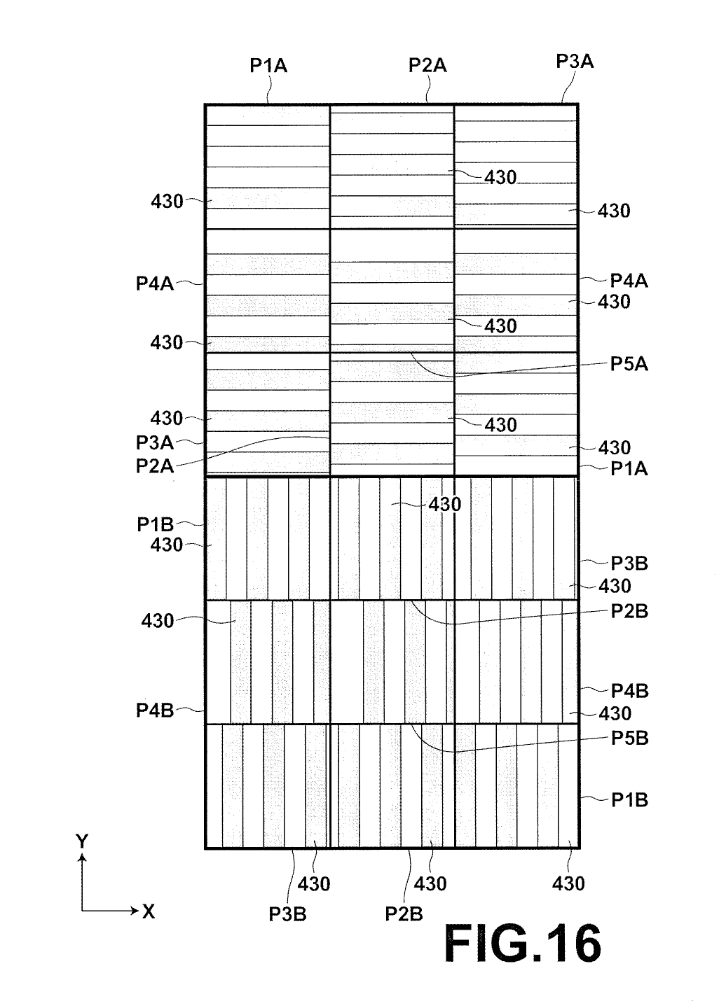

The electric charge storing layer 430 of the radiographic image detector 400 with the function of the second grating 3 has a shape that is different from the shape of the electric charge storing layer of the above-described radiographic image detector 50 of the optical reading system. As shown in FIG. 16, the electric charge storing layer 430 of the radiographic image detector 400 has sub-unit grating patterns, which have the same shapes as the sub-unit gratings of the second grating 3 described above.

A unit grating pattern P1A shown in FIG. 16 has a shape corresponding to the sub-unit grating SUG1A shown in FIG. 5, a unit grating pattern P2A has a shape corresponding to the sub-unit grating SUG2A shown in FIG. 5, a unit grating pattern P3A has a shape corresponding to the sub-unit grating SUG3A shown in FIG. 5, a unit grating pattern P4A has a shape corresponding to the sub-unit grating SUG4A shown in FIG. 5, and a unit grating pattern P5A has a shape corresponding to the sub-unit grating SUG5A shown in FIG. 5.

Further, a unit grating pattern P1B shown in FIG. 16 has a shape corresponding to the sub-unit grating SUG1B shown in FIG. 5, a unit grating pattern P2B has a shape corresponding to the sub-unit grating SUG2B shown in FIG. 5, a unit grating pattern P3B has a shape corresponding to the sub-unit grating SUG3B shown in FIG. 5, a unit grating pattern P4B has a shape corresponding to the sub-unit grating SUG4B shown in FIG. 5, and a unit grating pattern P5B has a shape corresponding to the sub-unit grating SUG5B shown in FIG. 5.

While the dividing pitch of sub-unit grating sections forming each sub-unit grating pattern of the electric charge storing layer 430 is finer than the arrangement pitch of the transparent linear electrodes 450a or the light-shielding linear electrodes 450b, the arrangement pitch P₂

and the interval d₂ of the sub-unit grating sections are the same as those of the sub-unit grating members 32 of the sub-unit gratings of the second grating 3 of the above-described embodiment.

The electric charge storing layer 430 is formed to have a thickness of 2 μm or less in the direction in which the layers are stacked (the Z-direction).

The electric charge storing layer 430 can be formed, for example, by resistance heating vapor deposition using the above-described material and a mask, such as a metal mask formed by forming holes in a metal sheet or a mask formed by a fiber. The electric charge storing layer 430 can also be formed by photolithography.

The condition of the distance between the first grating 2 and the radiographic image detector 400 to provide the function as a Talbot interferometer is the same as the condition of the distance between the first grating 2 and the second grating 3, since the radiographic image detector 400 functions as the second grating 3. Alternatively, as described with respect to the second embodiment, the first grating 2 may be adapted to project the incident radiation without diffracting the radiation, and the distance Z₂ from the first grating 2 to the radiographic image detector 400 may be set irrespectively of the Talbot interference distance, and may be set to satisfy Expression (20) above.

Next, the operation of the radiographic image detector 400 having the above-described configuration is described.

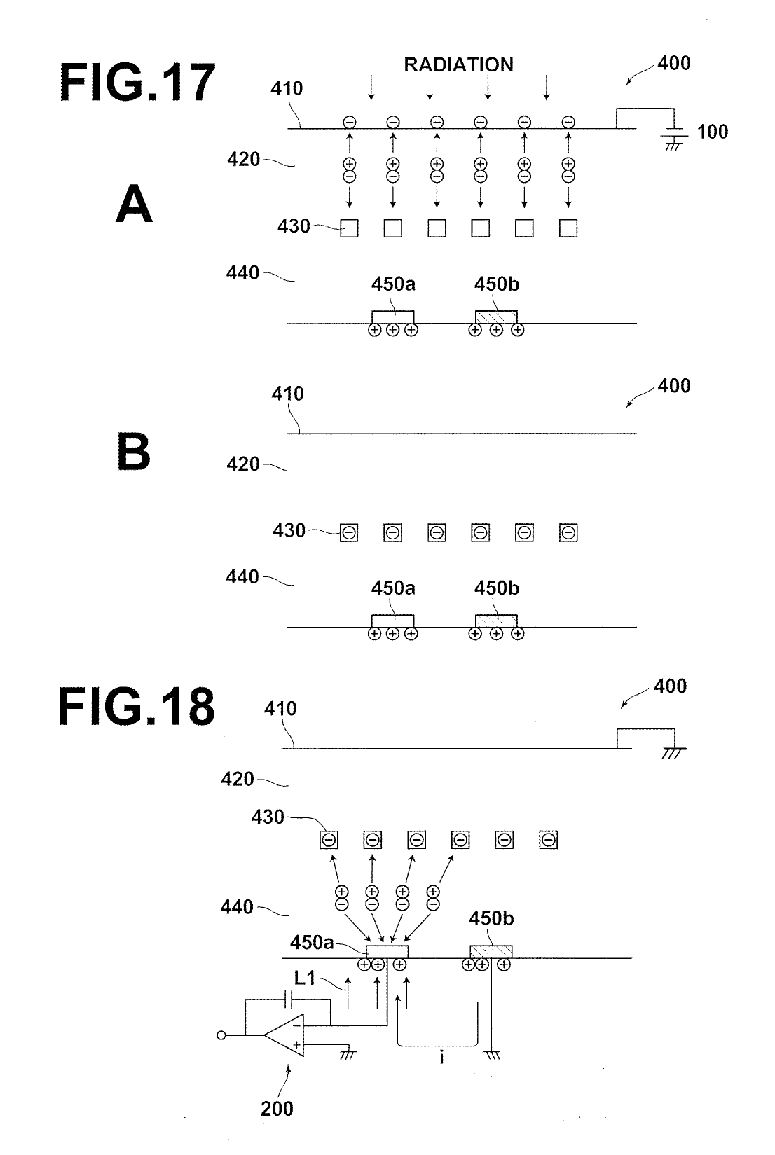

First, as shown at “A” in FIG. 17, in a state where a high-voltage power supply 100 applies a negative voltage to the first electrode layer 410 of the radiographic image detector 400, radiation carrying the self images G1 and G2 of the first grating 2 formed by the Talbot effect is applied to the radiographic image detector 400 from the first electrode layer 410 side thereof.

Then, the radiation applied to the radiographic image detector 400 is transmitted through the first electrode layer 410 to be applied to the recording photoconductive layer 420. The application of the radiation causes generation of electron-hole pairs at the recording photoconductive layer 420. Among the generated electric charge pairs, positive electric charges are combined with negative electric charges charged in the first electrode layer 410 and disappear, and negative electric charges are stored as latent image electric charges in the electric charge storing layer 430 (see “B” in FIG. 17).

Since the electric charge storing layer 430 is divided into the sub-unit grating patterns with the arrangement pitch as described above, only parts of the electric charges generated at the recording photoconductive layer 420 according to the self images G1 and G2 of the first grating 2, which are included in areas where the electric charge storing layer 430 is present immediately below, are trapped by the electric charge storing layer 430 to be stored. The remaining electric charges pass through the linear gaps in the electric charge storing layer 430 and through the reading photoconductive layer 440, and then flow out to the transparent linear electrodes 450a and the light-shielding linear electrodes 450b.

In this manner, only parts of the electric charges generated at the recording photoconductive layer 420 in areas with the electric charge storing layer 430 present immediately below are stored. With this operation, the self images G1 and G2 of the unit gratings of the first grating 2 are subjected to intensity modulation by being superposed on the sub-unit grating patterns of the electric charge storing layer 430, and image signals of fringe images which reflect the distortion of the wave front of the self images G1 and G2 due to the subject are stored in the electric charge storing layer 430. That is, the electric charge storing layer 430 function equivalently to the second grating 3 of the above-described embodiment.

Then, as shown in FIG. 18, in a state where the first electrode layer 410 is grounded, the linear reading light L1 emitted from the linear reading light source 60 is applied to the radiographic image detector 400 from the second electrode layer 450 side thereof. The reading light L1 is transmitted through the transparent linear electrodes 450a to be applied to the reading photoconductive layer 440. Positive electric charges generated at the reading photoconductive layer 440 by the application of the reading light L1 are combined with the latent image electric charges stored in the electric charge storing layer 430. Negative electric charges generated at the reading photoconductive layer 440 by the application of the reading light L1 are combined with positive electric charges charged in the light-shielding linear electrodes 450b via the charge amplifier 200 connected to the transparent linear electrodes 450a.

When the negative electric charges generated at the reading photoconductive layer 440 are combined with the positive electric charges charged in the light-shielding linear electrodes 450b, electric currents flow to the charge amplifier 200, and the electric currents are integrated and detected as an image signal.

As the linear reading light source 60 is moved along the sub-scanning direction (the Y-direction), the linear reading light L1 scans the radiographic image detector 400. Then, for each reading line exposed to the linear reading light L1, the image signals read out by the above-described operation are sequentially detected, and the detected image signals of each reading line are sequentially inputted to and stored in the image generation unit 5.

In this manner, the entire surface of the radiographic image detector 400 is scanned by the reading light L1, and the image signals of a whole single frame are outputted to the image generation unit 5.

Then, similarly to the first embodiment, the image generation unit 5 calculates the X-direction component pixel signal and the Y-direction component pixel signal based on the detection signals corresponding to the five types of sub-unit grating patterns and generates a pixel signal of one pixel of the phase contrast image based on the X-direction component pixel signal and the Y-direction component pixel signal.

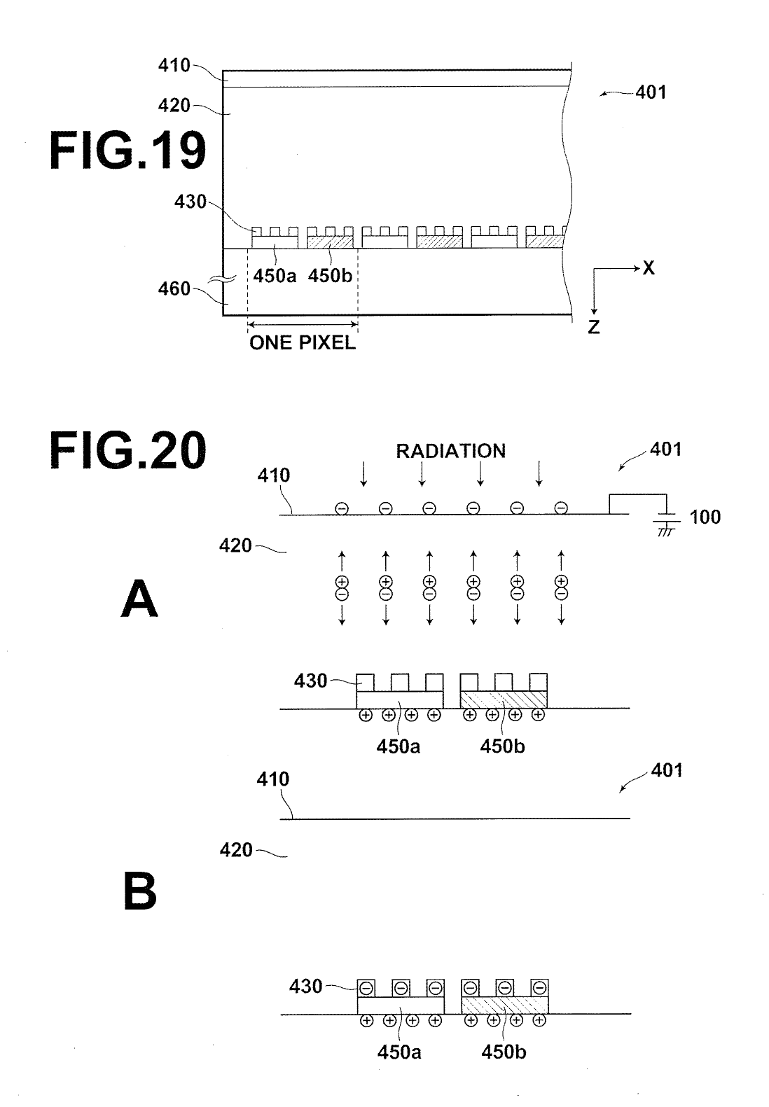

Although, the above-described radiographic image detector 400 with the function of the second grating 3 has the three layers including the recording photoconductive layer 420, the electric charge storing layer 430 and the reading photoconductive layer 440 between the electrodes, this layer structure is not essential. For example, as shown in FIG. 19, the electric charge storing layer 430 having the sub-unit grating patterns may be provided to directly contact the transparent linear electrodes 450a and the light-shielding linear electrodes 450b of the second electrode layer with omitting the reading photoconductive layer 440, and the recording photoconductive layer 420 maybe provided on the electric charge storing layer 430. In this case, the recording photoconductive layer 420 also functions as the reading photoconductive layer.

The structure of this radiographic image detector 401, where the electric charge storing layer 430 is provided directly on the second electrode layer 450 without the reading photoconductive layer 440 disposed therebetween, facilitates formation of the electric charge storing layer 430 having the sub-unit grating patterns by allowing formation of the linear patterns of the electric charge storing layer 430 through vapor deposition. During the vapor deposition, a mask, such as a metal mask, is used to selectively form the sub-unit grating patterns. In the case where the electric charge storing layer 430 having the sub-unit grating patterns is formed on the reading photoconductive layer 440, it is necessary to set the metal mask for forming the linear patterns of the electric charge storing layer 430 through vapor deposition after vapor deposition to form the reading photoconductive layer 440, and this operation, which is carried out in the atmosphere between the vapor deposition to form the reading photoconductive layer 440 and vapor deposition to form the recording photoconductive layer 420, may cause deterioration of the quality, such as deterioration of the reading photoconductive layer 440 and/or introduction of foreign matter between the photoconductive layers. In contrast, with the above-described structure where the reading photoconductive layer 440 is not provided, the number of operations carried out in the atmosphere after the vapor deposition to form the photoconductive layer can be reduced, and the above-described possibility of quality deterioration can be reduced.

The materials forming the recording photoconductive layer 420 and the electric charge storing layer 430 are the same as those for the above-described radiographic image detector 400. Also, the shapes of the sub-unit grating patterns of the electric charge storing layer 430 are the same as those in the above-described radiographic image detector.

Now, an operation of recording and reading a radiographic image with the radiographic image detector 401 is described.

First, as shown at “A” in FIG. 20, in a state where the high-voltage power supply 100 applies a negative voltage to the first electrode layer 410 of the radiographic image detector 401, radiation carrying the self images G1 and G2 of the first grating 2 is applied to the radiographic image detector 401 from the first electrode layer 410 side thereof.

Then, the radiation applied to the radiographic image detector 401 is transmitted through the first electrode layer 410 to be applied to the recording photoconductive layer 420. The application of the radiation causes generation of electron-hole pairs at the recording photoconductive layer 420. Among the generated electric charge pairs, positive electric charges are combined with negative electric charges charged in the first electrode layer 410 and disappear, and negative electric charges are stored as latent image electric charges in the electric charge storing layer 430 (see “B” in FIG. 20). Since the electric charge storing layer 430 having the sub-unit grating patterns and contacting the second electrode layer 450 is formed by an insulating film, the electric charges reaching the electric charge storing layer 430 are captured and stored there without further traveling to the second electrode layer 450.

Similarly to the above-described radiographic image detector 400, only parts of the electric charges generated at the recording photoconductive layer 420 in areas with the electric charge storing layer 430 having the sub-unit grating patterns present immediately below are stored. With this operation, the self images G1 and G2 of the first grating 2 are subjected to intensity modulation by being superposed on the sub-unit grating patterns of the electric charge storing layer 430, and image signals of fringe images which reflect the distortion of the wave front of the self images G1 and G2 due to the subject are stored in the electric charge storing layer 430.

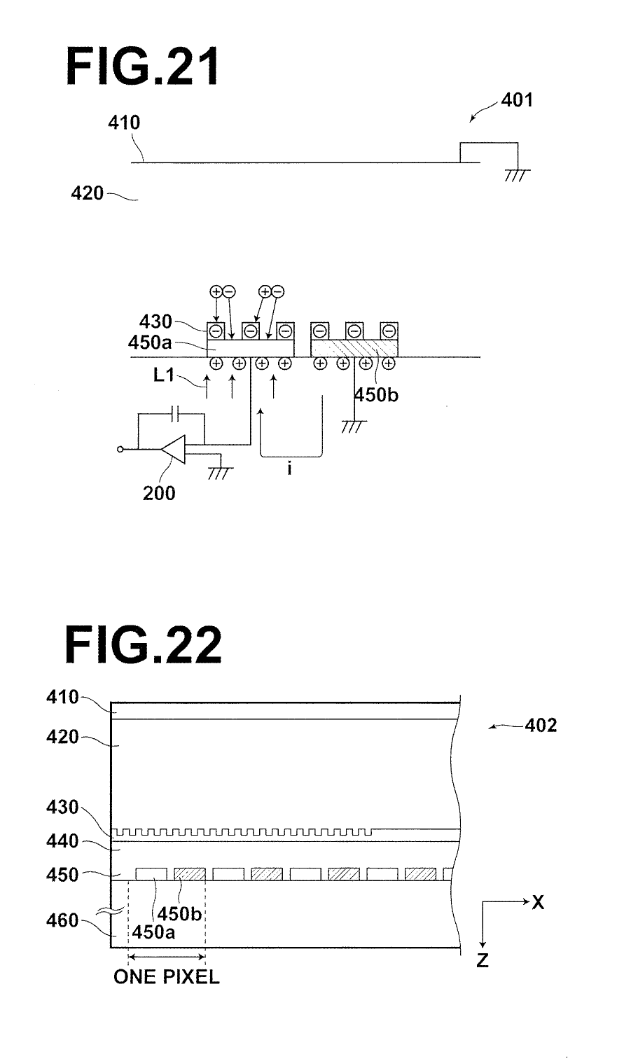

Then, as shown in FIG. 21, in a state where the first electrode layer 410 is grounded, the linear reading light L1 emitted from the linear reading light source 60 is applied to the radiographic image detector 401 from the second electrode layer 450 side thereof. The reading light L1 is transmitted through the transparent linear electrodes 450a to be applied to areas of the reading photoconductive layer 440 in the vicinity of the electric charge storing layer 430. Positive electric charges generated by the application of the reading light L1 are drawn toward the linear electric charge storing layer 430 and are recombined. Negative electric charges generated by the application of the reading light L1 are drawn toward the transparent linear electrodes 450a, and are combined with positive electric charges charged in the transparent linear electrodes 450a and positive electric charges charged in the light-shielding linear electrodes 450b via the charge amplifier 200 connected to the transparent linear electrodes 450a. With this, electric currents flow to the charge amplifier 200, and the electric currents are integrated and detected as an image signal.

Although the electric charge storing layer 430 in the above-described radiographic image detectors 400 and 401 is completely separated into lines to form the sub-unit grating patterns, this is not intended to limit the invention. For example, as in a radiographic image detector 402 shown in FIG. 22, the electric charge storing layers 430 having the sub-unit grating patterns may be formed by forming linear patterns in a flat plate-shaped layer.

Although the electric charge storing layer 430 in the above-described radiographic image detectors 400 to 402 is formed to have the sub-unit grating patterns similarly to the second grating 3 of the above-described embodiments, this is not intended to limit the invention. For example, the configuration of the unit gratings of the first grating 2 of the above-described embodiments may be applied to the electric charge storing layer 430, and the configuration of the second grating 3 of the above-described embodiments may be applied to the first grating 2. Namely, the electric charge storing layer 430 may be formed by a lot of unit grating patterns, and the first grating 2 may be formed by a lot of sub-unit gratings.

Although the second grating 3 in the above-described embodiments are formed by the different types of sub-unit gratings to obtain the detection signals with different types of phase information, this is not intended to limit the invention. For example, the second grating 3 may be formed by arranging, along the X-direction, linear grating members extending in the Y-direction at the arrangement pitch P₂ with the interval d₂. Then, detection signals of the pixel circuits 40 in a range corresponding to the first unit gratings UG1 may be obtained with shifting the second grating 3 in increments of P₂/M in the X-direction by a predetermined shifting mechanism to obtain M types of detection signals, and detection signals of the pixel circuits 40 in a range corresponding to the second unit gratings UG2 may be obtained with shifting the second grating 3 in increments of P₂/M in the Y-direction by the predetermined shifting mechanism to obtain M types of detection signals. Further alternatively, M types of detection signals with respect to the X-direction and M types of detection signals with respect to the Y-direction can be obtained by obtaining detection signals of the pixel circuits 40 with shifting the second grating 3 in a diagonal direction at an angle of 45 degrees relative to the X-direction.

Further, in the case where the above-described radiographic image detector with the function of the second grating 3 is used, the electric charge storing layer 430 may have linear grating patterns extending in the Y-direction arranged along the X-direction at the arrangement pitch P₂ with the interval d₂, as described above, and the radiographic image detector may be shifted as described above.

Further, the radiographic imaging apparatuses of the above-described embodiments allows obtaining image signals having different types of phase information in a single imaging operation, and therefore allows use of a storage phosphor sheet or a silver halide film, besides the semiconductor detector as described above, which can be repeatedly used immediately. In this case, pixels obtained by scanning a storage phosphor sheet or a developed silver halide film are equivalent to “pixel sections” in the claims.

The radiographic imaging apparatuses of the above-described embodiments are also applicable to a breast imaging and display system for taking a breast image, a radiographic imaging system that images a subject in the upright position, a radiographic imaging system that images a subject in the supine position, a radiographic imaging system that can image a subject in the upright position and the supine position, a radiographic imaging system that carries out long-length imaging, etc.

Further, the radiographic imaging apparatuses of the above-described embodiments are also applicable to a radiographic phase-contrast CT apparatus that obtains a three-dimensional image, a stereo imaging apparatus that obtains a stereo image which can be stereoscopically viewed, a tomosynthesis imaging apparatus for obtaining a tomographic image, etc.

What is claimed is:

1. A radiographic imaging apparatus comprising:
a first grating having a periodically arranged grating structure and allowing radiation emitted from a radiation source to pass therethrough to form a first periodic pattern image;
a second grating having a periodically arranged grating structure to receive the first periodic pattern image and form a second periodic pattern image;
a radiographic image detector including two-dimensionally arranged pixel sections to detect the second periodic pattern image formed by the second grating; and
an image generation unit to generate a phase contrast image based on the image signal representing the second periodic pattern image detected by the radiographic image detector,
wherein one of the first grating and the second grating includes a plurality of unit gratings arranged in a predetermined range corresponding to each pixel forming the phase contrast image, wherein the unit gratings are formed by sets of unit grating members extending in different directions from each other, and
the image generation unit generates a pixel signal of each pixel of the phase contrast image based on a plurality of detection signals detected by the pixel sections corresponding to the unit gratings in the predetermined range.

2. The radiographic imaging apparatus as claimed in claim 1, wherein the other of the gratings includes a plurality of sub-unit gratings arranged therein, each sub-unit grating is formed by a unit smaller than the unit grating and corresponding to each pixel section, and the sub-unit gratings in a range corresponding to each unit grating are arranged with being parallel shifted by different distances relative to the unit grating in a direction orthogonal to a direction in which the unit grating extends, and
the image generation unit generates a detection signal of each unit grating based on detection signals detected by the pixel sections corresponding to the sub-unit gratings arranged in the range corresponding to the unit grating.

3. The radiographic imaging apparatus as claimed in claim 2, wherein the first grating includes the plurality of unit gratings arranged therein and the second grating includes the plurality of sub-unit gratings arranged therein, and
the sub-unit gratings in the range corresponding to each unit grating of the first grating are arranged with being parallel shifted by different distances in increments of P/M relative to the image of the first grating, where P is a pitch of the second grating and M is a number of pieces of phase information set in advance to be used to generate each pixel forming the phase contrast image.

4. The radiographic imaging apparatus as claimed in claim 2, wherein
the second grating includes the plurality of unit gratings arranged therein and the first grating includes the plurality of sub-unit gratings arranged therein, and
images of the sub-unit gratings in the range corresponding to each unit grating of the second grating are arranged with being parallel shifted by different distances in increments of P/M relative to the second grating, where P is a pitch of the second grating and M is a number of pieces of phase information set in advance to be used to generate each pixel forming the phase contrast image.

5. The radiographic imaging apparatus as claimed in claim 1, wherein the unit gratings are formed by sets of unit grating members extending in different directions from each other.

6. The radiographic imaging apparatus as claimed in claim 1, wherein the unit gratings in the predetermined range are arranged in an alternating pattern.

7. The radiographic imaging apparatus as claimed in claim 1, wherein the unit gratings arranged in the predetermined range comprise different types of unit gratings having an equal area ratio in the predetermined range.

8. The radiographic imaging apparatus as claimed in claim 1, wherein the unit gratings arranged in the predetermined range comprise two or more unit gratings formed by the unit grating members extending in the same direction, wherein the two or more unit gratings have different arrangement pitches of the unit grating members from each other.

9. The radiographic imaging apparatus as claimed in claim 2, wherein the sub-unit gratings arranged in the range corresponding to each unit grating comprise different types of sub-unit gratings with different arrangement pitches.

10. The radiographic imaging apparatus as claimed in claim 1, wherein the second grating is positioned at a Talbot interference distance from the first grating and applies intensity modulation to the first periodic pattern image of the first grating formed by a Talbot interference effect.

11. The radiographic imaging apparatus as claimed in claim 1, wherein the first grating is an absorption type grating and allows the radiation to pass therethrough as a projection image to form the first periodic pattern image, and
the second grating applies intensity modulation to the first periodic pattern image which is the projection image passed through the first grating.

12. The radiographic imaging apparatus as claimed in claim 11, wherein the second grating is positioned at a distance shorter than a minimum Talbot interference distance from the first grating.

13. A radiographic imaging apparatus comprising:
a grating having a periodically arranged grating structure and allowing radiation emitted from a radiation source to pass therethrough to form a periodic pattern image;
a radiographic image detector including a first electrode layer transmitting therethrough the periodic pattern image formed by the grating, a photoconductive layer to generate electric charges when exposed to the periodic pattern image transmitted through the first electrode layer, an electric charge storing layer to store the electric charges generated at the photoconductive layer, and a second electrode layer including a lot of linear electrodes transmitting reading light therethrough, the layers being formed in this order, wherein a detection signal of each pixel section corresponding to each linear electrode is read out by scanning with the reading light; and
an image generation unit to generate a phase contrast image based on an image signal representing the periodic pattern image detected by the radiographic image detector,
wherein the electric charge storing layer has a grating pattern with a pitch finer than an arrangement pitch of the linear electrodes,
the grating includes a plurality of unit gratings arranged in a predetermined range corresponding to each pixel forming the phase contrast image, wherein the unit gratings are formed by sets of unit grating members extending in different directions from each other, and
the image generation unit generates a pixel signal of each pixel of the phase contrast image based on a plurality of detection signals detected by the pixel sections corresponding to the unit gratings in the predetermined range.

14. The radiographic imaging apparatus as claimed in claim 13, wherein the electric charge storing layer includes a plurality of sub-unit grating patterns arranged therein, each sub-unit grating pattern is formed by a unit smaller than the unit grating and corresponding to each pixel section, and the sub-unit grating patterns in a range corresponding to each unit grating are arranged with being parallel shifted by different distances relative to the unit grating in a direction orthogonal to a direction in which the unit grating extends, and
the image generation unit generates a detection signal of each unit grating based on detection signals detected by the pixel sections corresponding to the sub-unit grating patterns arranged in the range corresponding to the unit grating.

15. The radiographic imaging apparatus as claimed in claim 14, wherein the sub-unit grating patterns in the range corresponding to each unit grating of the grating are arranged with being parallel shifted by different distances in increments of P/M relative to the image of the grating, where P is a pitch of the sub-unit grating patterns and M is a number of pieces of phase information set in advance to be used to generate each pixel forming the phase contrast image.

16. The radiographic imaging apparatus as claimed in claim 13, wherein the unit gratings are formed by sets of unit grating members extending in different directions from each other.

17. The radiographic imaging apparatus as claimed in claim 13, wherein the unit gratings in the predetermined range are arranged in an alternating pattern.

18. The radiographic imaging apparatus as claimed in claim 13, wherein the unit gratings arranged in the predetermined range comprise different types of unit gratings having an equal area ratio in the predetermined range.

19. The radiographic imaging apparatus as claimed in claim 13, wherein the unit gratings arranged in the predetermined range comprise two or more unit gratings formed by the unit grating members extending in the same direction, wherein the two or more unit gratings have different arrangement pitches of the unit grating members from each other.

20. The radiographic imaging apparatus as claimed in claim 14, wherein the sub-unit grating patterns arranged in the range corresponding to each unit grating comprise different types of sub-unit grating patterns with different arrangement pitches.

21. The radiographic imaging apparatus as claimed in claim 13, wherein the radiographic image detector is positioned at a Talbot interference distance from the grating and applies intensity modulation to the periodic pattern image of the grating formed by a Talbot interference effect.

22. The radiographic imaging apparatus as claimed in claim 13, wherein the grating is an absorption type grating and allows the radiation to pass therethrough as a projection image to form the periodic pattern image, and
the radiographic image detector applies intensity modulation to the periodic pattern image which is the projection image passed through the grating.

23. The radiographic imaging apparatus as claimed in claim 22, wherein the radiographic image detector is positioned at a distance shorter than a minimum Talbot interference distance from the grating.

24. A radiographic imaging apparatus comprising:
a grating having a periodically arranged grating structure and allowing radiation emitted from a radiation source to pass therethrough to form a periodic pattern image;
a radiographic image detector including a first electrode layer transmitting therethrough the periodic pattern image formed by the grating, a photoconductive layer to generate electric charges when exposed to the periodic pattern image transmitted through the first electrode layer, an electric charge storing layer to store the electric charges generated at the photoconductive layer, and a second electrode layer including a lot of linear electrodes transmitting reading light therethrough, the layers being formed in this order, wherein a detection signal of each pixel section corresponding to each linear electrode is read out by scanning with the reading light; and
an image generation unit to generate a phase contrast image based on an image signal representing the periodic pattern image detected by the radiographic image detector,
wherein the electric charge storing layer includes a plurality of unit grating patterns arranged in a predetermined range corresponding to each pixel forming the phase contrast image, wherein the unit grating patterns are formed by sets of unit grating sections extending in different directions from each other, and
the image generation unit generates a pixel signal of each pixel of the phase contrast image based on a plurality of detection signals detected by the pixel sections corresponding to the unit grating patterns in the predetermined range.

25. The radiographic imaging apparatus as claimed in claim 24, wherein the grating includes a plurality of sub-unit gratings arranged therein, each sub-unit grating is formed by a unit smaller than the unit grating pattern and corresponding to each pixel section, and the sub-unit gratings in a range corresponding to each unit grating pattern are arranged with being parallel shifted by different distances relative to the unit grating pattern in a direction orthogonal to a direction in which the unit grating pattern extends, and
the image generation unit generates a detection signal of each unit grating pattern based on detection signals detected by the pixel sections corresponding to the sub-unit gratings arranged in the range corresponding to the unit grating pattern.

26. The radiographic imaging apparatus as claimed in claim 25, wherein images of the sub-unit gratings in the range corresponding to each unit grating pattern of the electric charge storing layer are arranged with being parallel shifted by different distances in increments of P/M relative to the unit grating pattern, where P is a pitch of the unit grating pattern and M is a number of pieces of phase information set in advance to be used to generate each pixel forming the phase contrast image.

27. The radiographic imaging apparatus as claimed in claim 24, wherein the unit grating patterns are formed by sets of unit grating sections extending in directions orthogonal to each other.

28. The radiographic imaging apparatus as claimed in claim 24, wherein the unit grating patterns in the predetermined range are arranged in an alternating pattern.

29. The radiographic imaging apparatus as claimed in claim 24, wherein the unit grating patterns arranged in the predetermined range comprise different types of unit grating patterns having an equal area ratio in the predetermined range.

30. The radiographic imaging apparatus as claimed in claim 24, wherein the unit grating patterns arranged in the predetermined range comprise two or more unit grating patterns formed by the unit grating sections extending in the same direction, wherein the two or more unit grating patterns have different arrangement pitches of the unit grating sections from each other.

31. The radiographic imaging apparatus as claimed in claim 25, wherein the sub-unit gratings arranged in the range corresponding to each unit grating pattern comprise different types of sub-unit gratings with different arrangement pitches.

32. The radiographic imaging apparatus as claimed in claim 24, wherein the radiographic image detector is positioned at a Talbot interference distance from the grating and applies intensity modulation to the periodic pattern image of the grating formed by a Talbot interference effect.

33. The radiographic imaging apparatus as claimed in claim 24, wherein the grating is an absorption type grating and allows the radiation to pass therethrough as a projection image to form the periodic pattern image, and
the radiographic image detector applies intensity modulation to the periodic pattern image which is the projection image passed through the grating.

34. The radiographic imaging apparatus as claimed in claim 33, wherein the radiographic image detector is positioned at a distance shorter than a minimum Talbot interference distance from the grating.

35. A radiographic image detector comprising:
a first electrode layer transmitting radiation;
a photoconductive layer to generate electric charges when exposed to the radiation transmitted through the first electrode layer;
an electric charge storing layer to store the electric charges generated at the photoconductive layer; and
a second electrode layer including a lot of linear electrodes transmitting reading light therethrough, the layers being formed in this order, wherein a detection signal of each pixel section corresponding to each linear electrode is read out by scanning with the reading light,
wherein the electric charge storing layer includes a plurality of unit grating patterns arranged in a predetermined range, wherein the unit grating patterns are formed by sets of unit grating sections extending in different directions from each other.
